(19) United States
(12) Patent Application Publication
(10) Pub. No.: US 2017/0126921 A1
(43) Pub. Date: May 4, 2017

(54) Document Scanner-Copier with a Stationary Imaging and Illumination Engine

(71) Applicant: Gheorghe Olaru, Freiburg (DE)

(72) Inventor: Gheorghe Olaru, Freiburg (DE)

(21) Appl. No.: 15/338,926

(22) Filed: Oct. 31, 2016

Related U.S. Application Data
(60) Provisional application No. 62/249,173, filed on Oct. 30, 2015.

(51) Int. Cl. H04N 1/028; H04N 5/232; H04N 1/00

(52) U.S. Cl. CPC H04N 1/02805; H04N 1/00525; H04N 1/0288; H04N 5/23293; H04N 1/00827; H04N 2201/0081; H04N 2201/0084

(57) ABSTRACT

A compact and lighter image capturing device of increased spatial resolution (relative to the heads up scanners) and having a higher speed operates as a contact type document scanner. This scanner includes a static 2D array of lenses optically coupled to a static 2D array of color digital image sensors. A static light source dimensioned to match the surface of the document ensures a uniform illumination of the entire document. The entire document or any desired portions of the document can be scanned and saved without any mechanical movements. This scanner also works in a video-camera mode and a dedicated display is used to pre-proof and visualize live any image portions or the entire document before the image of the document is saved in a dedicated memory. The color balance and the position of the document and can be thus adjusted prior to scanning it by using its live image. An image segmentation mode is also available, where the display has a touch screen function coupled to the scanner that is used to select and or mask only some areas of the document that need to be scanned individually. This requires customized changes in the illumination and or image capturing. In one mode of operation, the scanner can be also fully used independently from a computer.

This application claims priority to U.S. Provisional Application Ser. No. 62/249,173, filed on Oct. 30, 2015, and incorporates the application in its entirety.

### BACKGROUND OF THE INVENTION

### Field of the Invention

This invention is related to a digital color image capturing device that operates as a document scanner or copier and methods of digital image capturing or scanning. More specifically, this invention is related to a desktop color image capturing device working as a scanner-copier having static lenses, static image sensors, a static illumination source and methods of documents scanning using such a scanner.

### BRIEF SUMMARY OF THE INVENTION

A color contact imaging device is used as a static scanner to capture the image of a document size A4 or A3. The document to be scanned can be a single page flat document or a bound book or magazine. The desktop static scanner is designed to work by direct contact with the document and has a modular and platform based configuration.

In several embodiments of the invention the contact static scanner includes a color imaging engine consisting of a static 2D array of area array monochromatic light sensors (such as CCDs and CMOS), a static 2D array of optical imaging elements and a static planar solid state illumination source matching the size of the document to be scanned, i.e. A4 or A3.

In several embodiments of the invention the planar illumination source is also quite thin and is positioned either at the level of an entrance aperture of the optical imaging elements or above the optical imaging elements. In both cases the planar illumination source is configured to create a uniform light intensity pattern onto the document to be captured without any shading caused by the optical imaging elements and their mechanical support.

In several embodiments of the invention key elements of the color imaging engine are removable and replaceable with elements having different optical and color characteristics that are more suitable for a specific scanning job.

In several embodiments of the invention the design was made having in mind a platform based product where based on the need of the application the optics and illumination and the sensors can be selected based on pre-designed and pre-manufactured assemblies and modules.

In several embodiments of the invention a color calibration step is performed from time to time, or for some special jobs quite frequently, to create and store a light distribution profile of the scanner on a specific date. The intensity distribution is captured using a target that best matches the paper or other substrate of the object to be scanned and is stored in a look up table. A color correction and light intensity correction step can be performed for certain documents to make sure the captured image has the right color and the right intensity.

In several embodiments of the invention the planar illumination source is an OLED thin sheet that is configured to deliver either white or sequences of RGB and other colors

In several embodiments of the invention the planar illumination source is an OLED.

In several embodiments of the invention automatic feeding of several documents to be scanned is provided in a very compact design.

In several embodiments of the invention the illumination of the document is done using planar light guides in conjunction with RGB LEDs.

According to one aspect of the invention a contact type document scanner includes a static 2D array of lenses optically coupled to a static 2D array of color digital image sensors. A static light source dimensioned to match the surface of the document ensures a uniform illumination of the entire document. The entire document or any desired portions of the document can be scanned and saved without any mechanical movements. This scanner also works in a video-camera mode and a display is used to pre-proof and visualize live any image portions or the entire document before the image of the document is saved in a dedicated memory. The color balance and the position of the document and can be thus adjusted prior to scanning it by using its live image. An image segmentation mode is also available, where the display has a touch screen function coupled to the scanner that is used to select and or mask only some areas of the document that need to be scanned individually. This requires customized changes in the illumination and or image capturing. In one mode of operation, the scanner can be also fully used independently from a computer.

### BRIEF DESCRIPTION OF THR DRAWINGS

FIG. 1 through FIG. 25e show various embodiments of the invention where the innovative scanner that can act as a copier in conjunction with a printer has various designs to serve various applications.

### DETAILED DESCRIPTION OF THE INVENTION

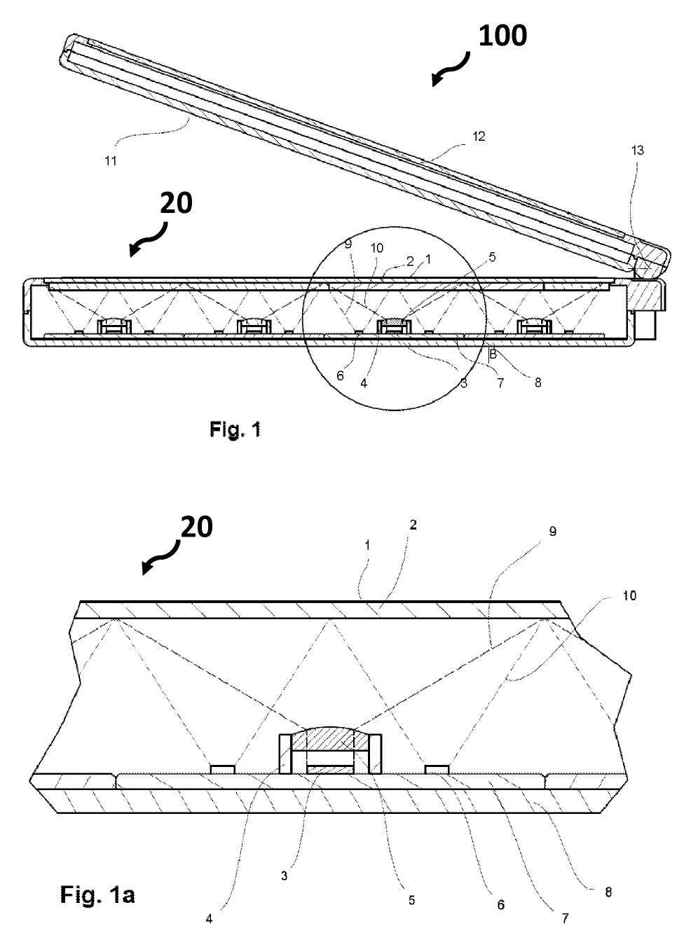

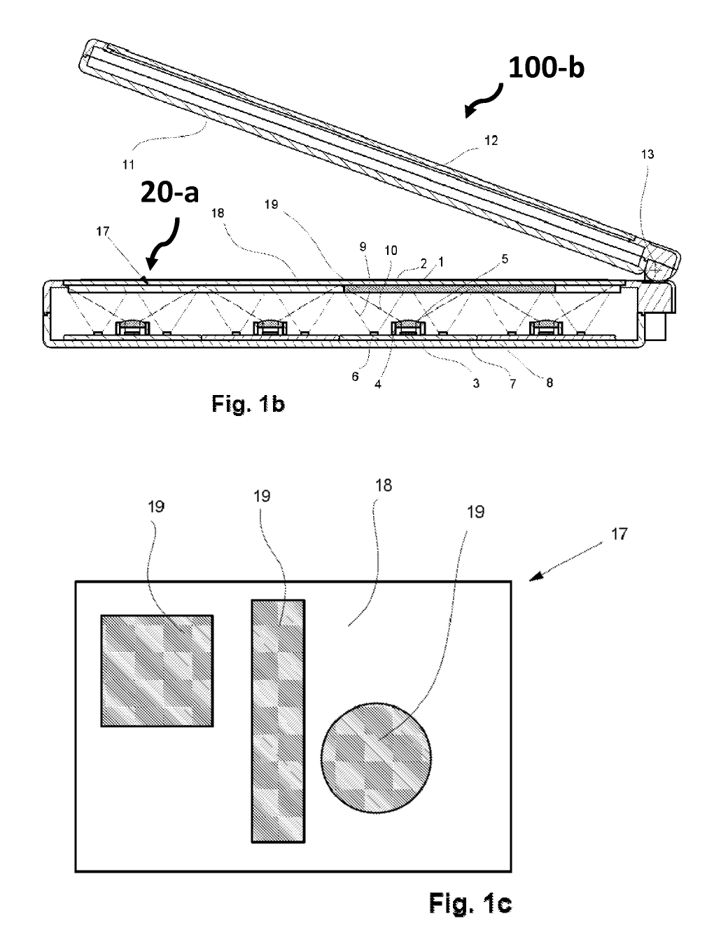

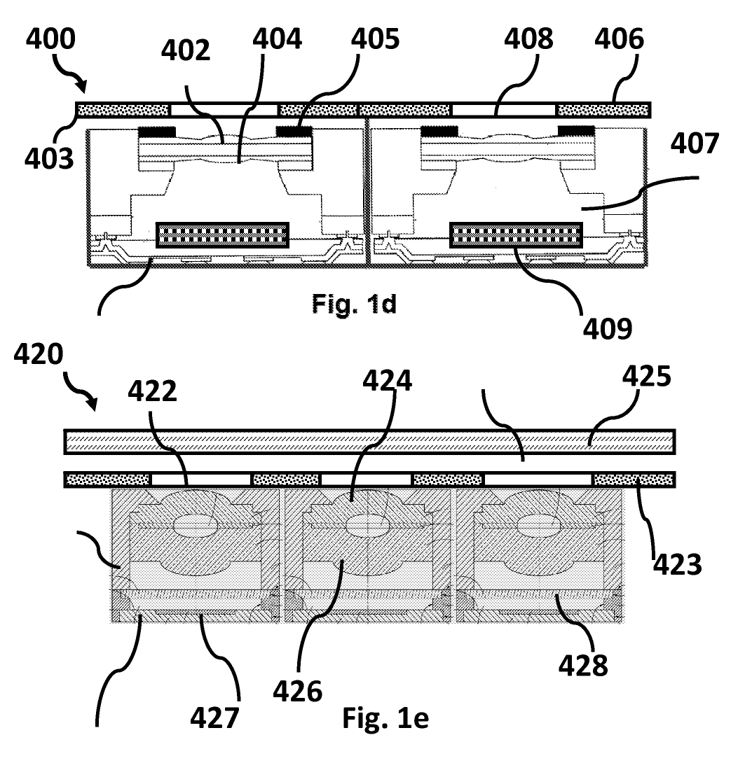

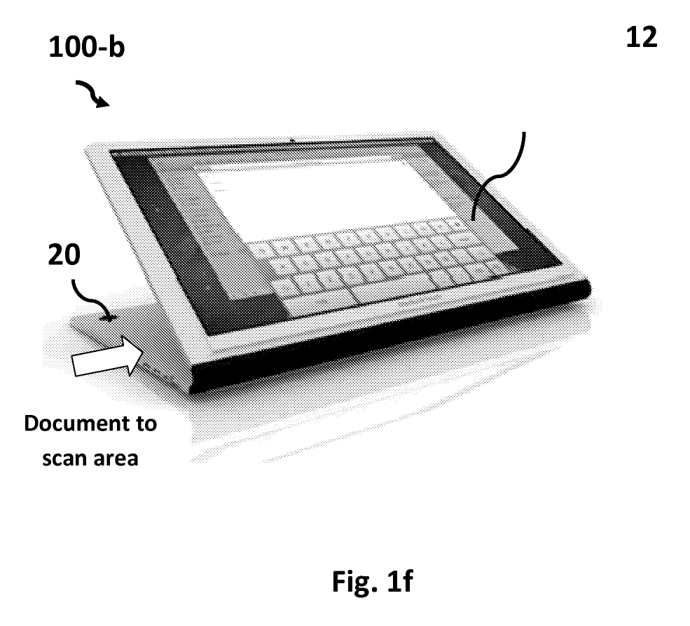

FIG. 1 show embodiments of the invention where the scanner 100-b includes a cover 12. In some embodiments the cover includes a flat display, that can be an LED or OLED display with or without a touch screen.

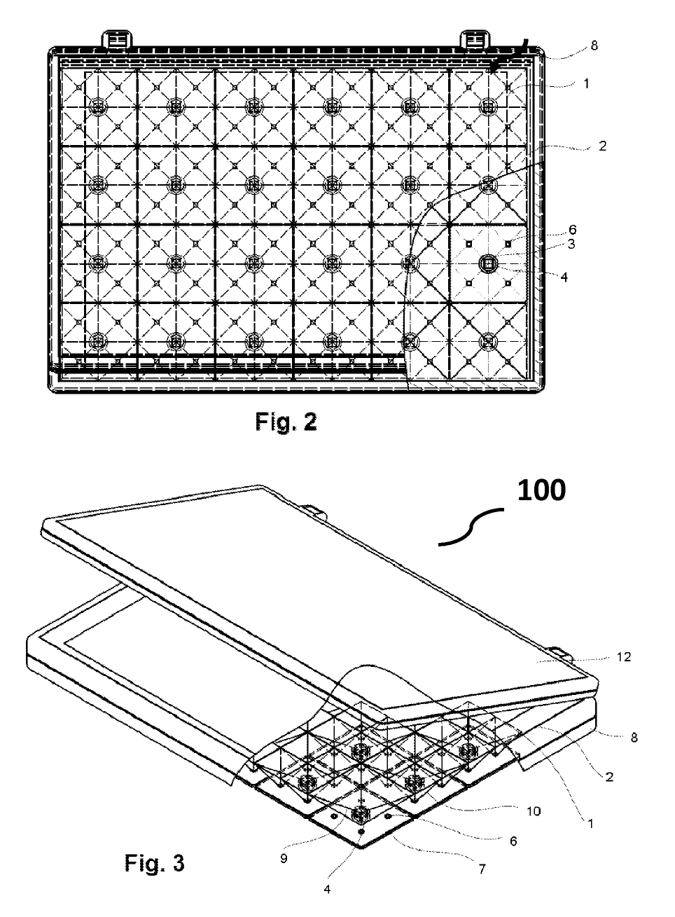

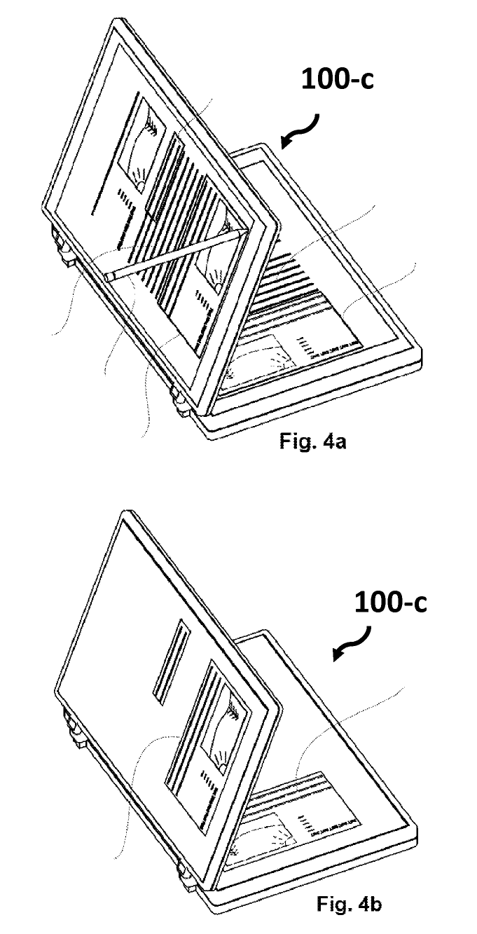

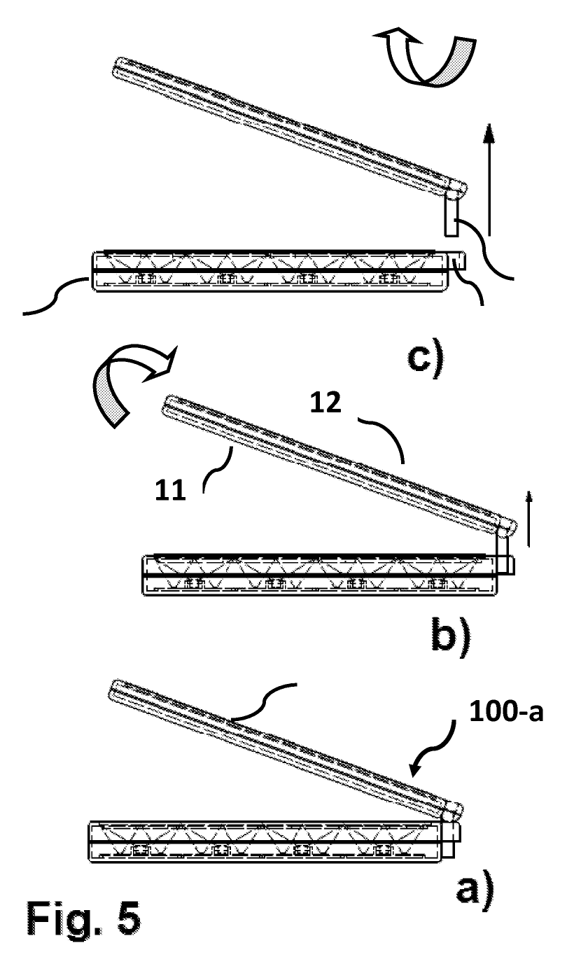

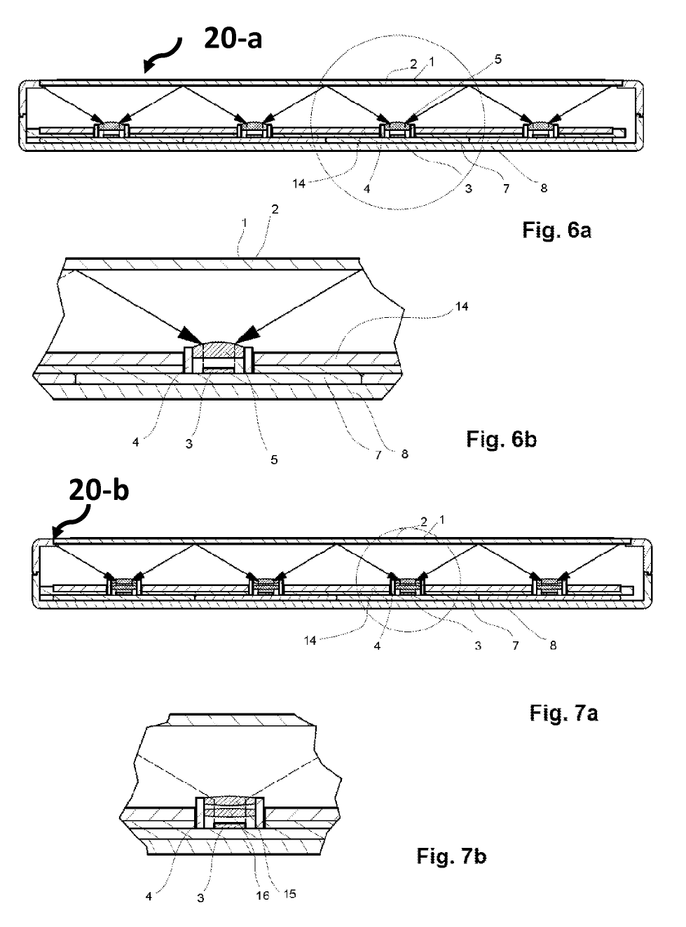

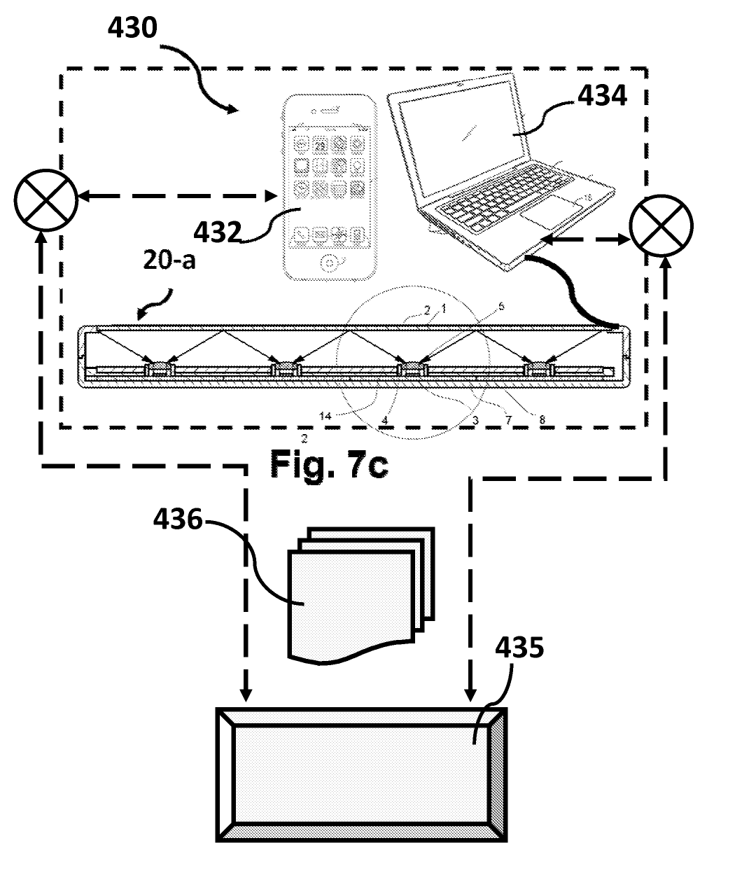

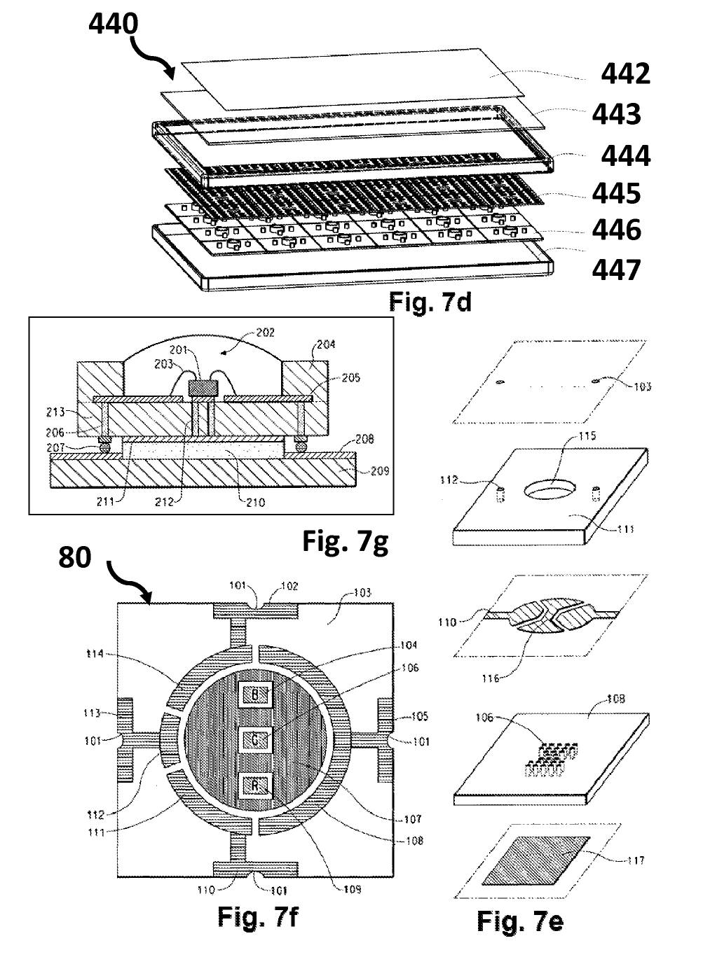

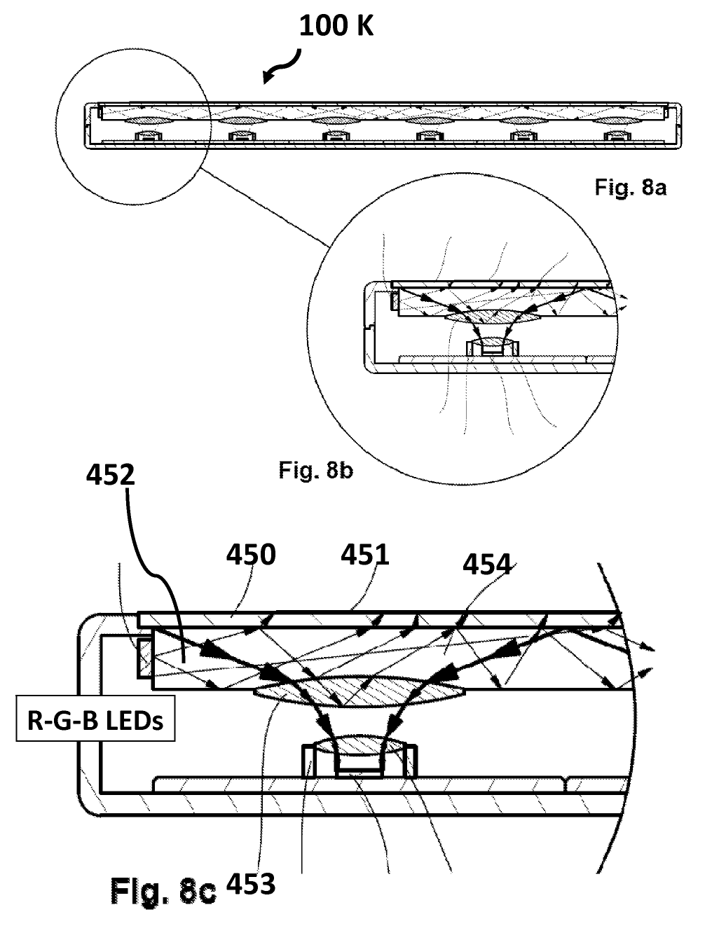

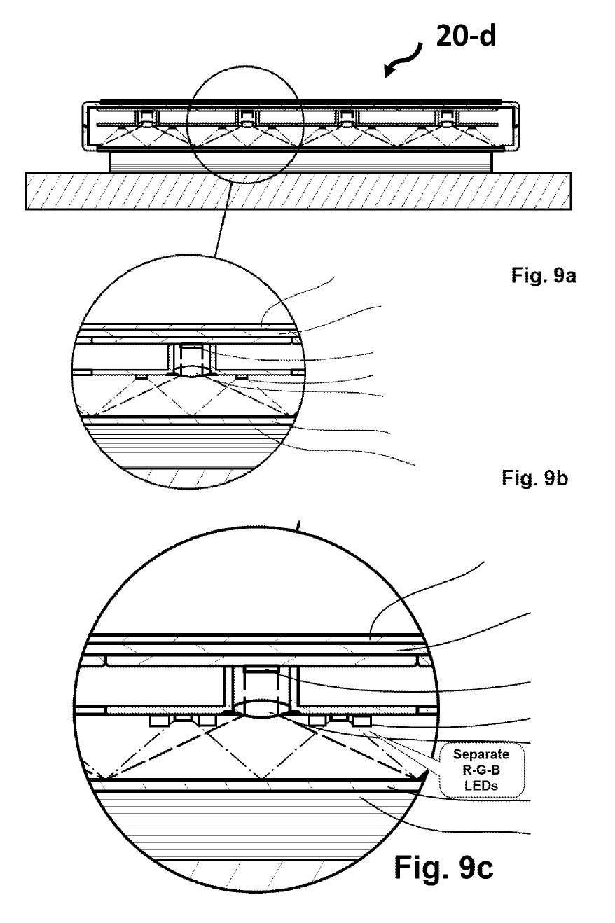

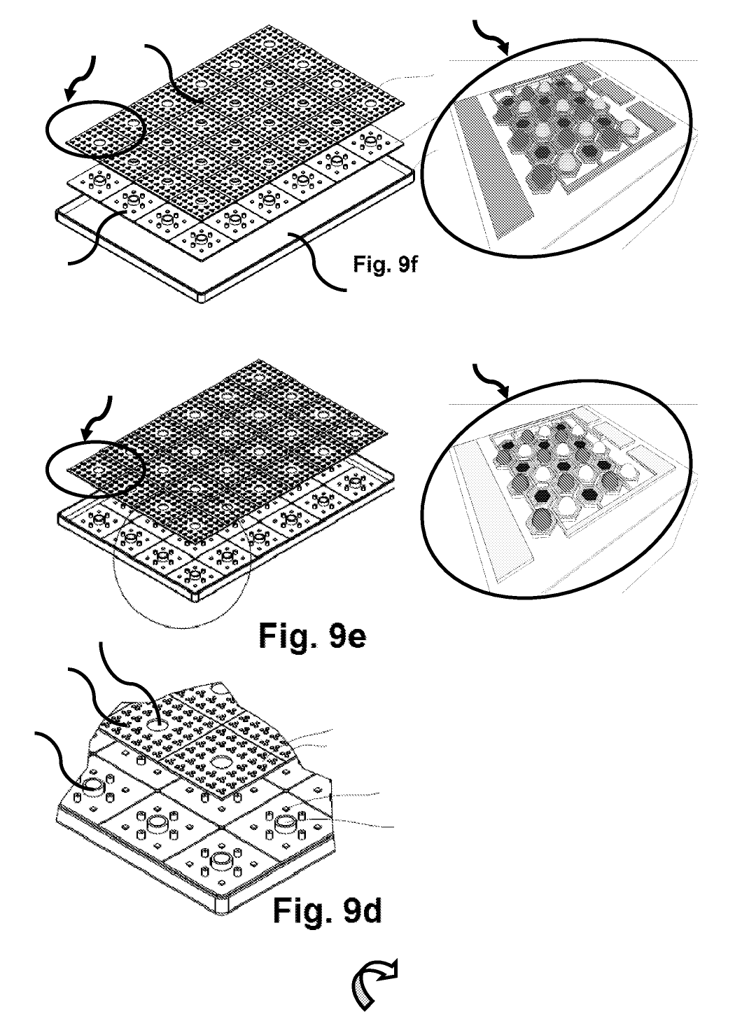

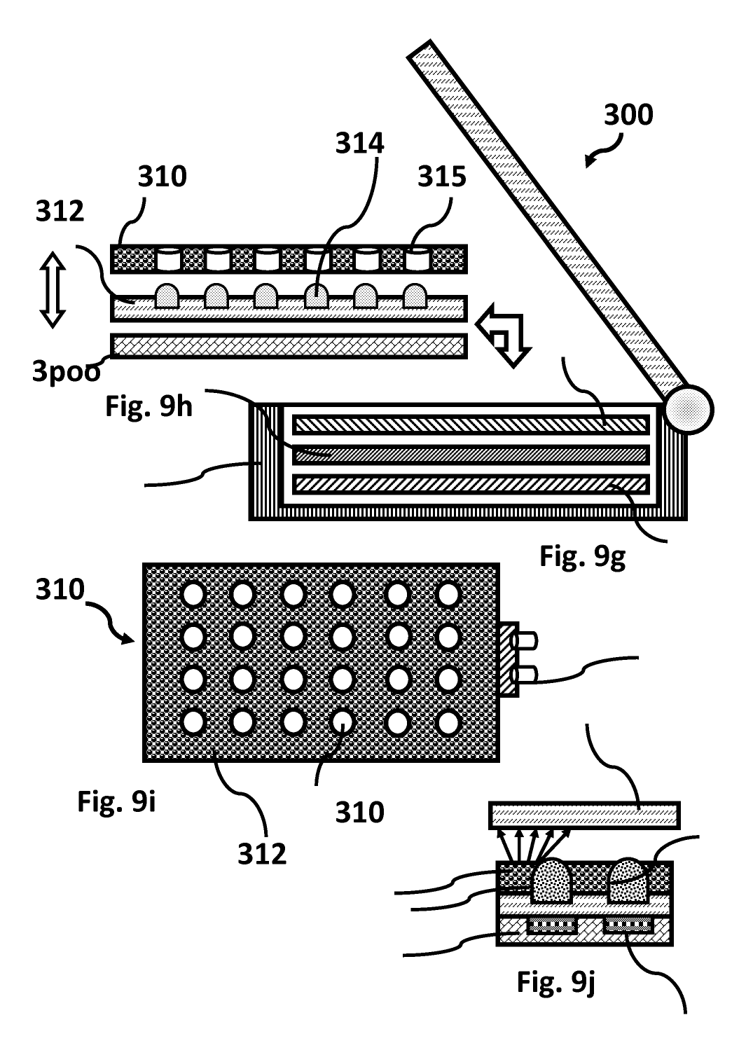

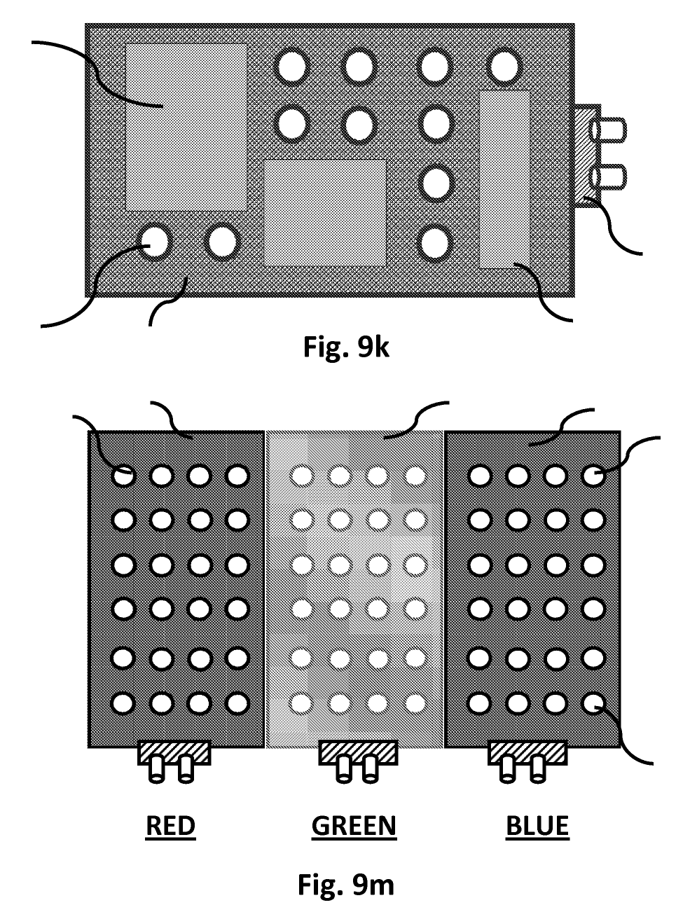

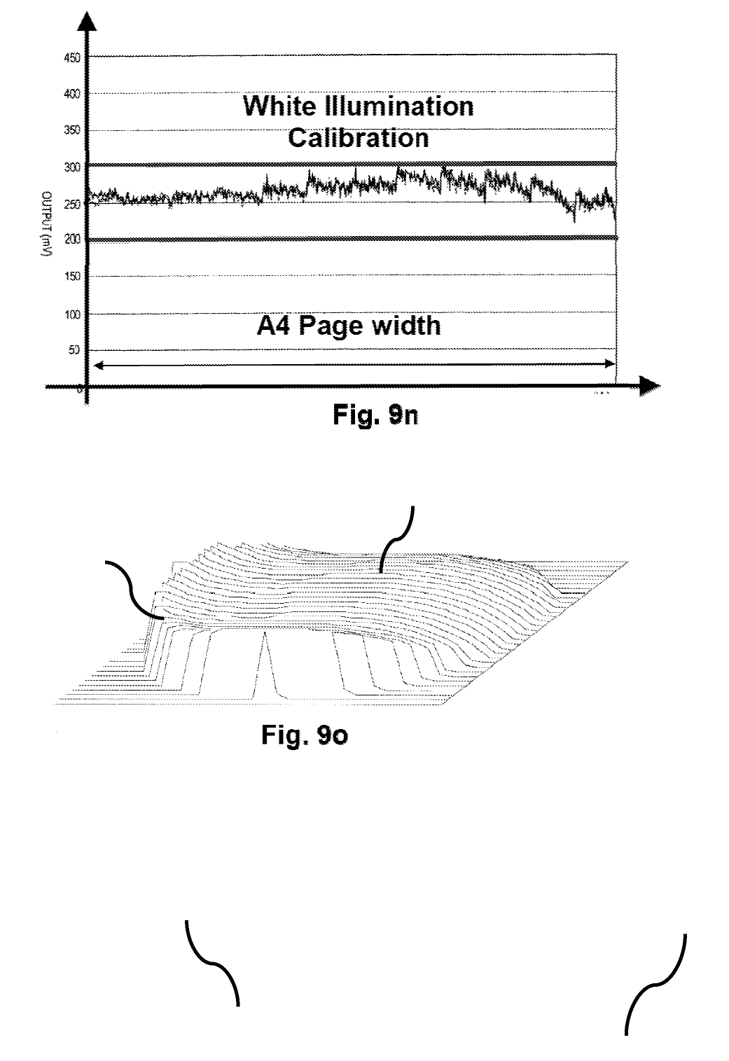

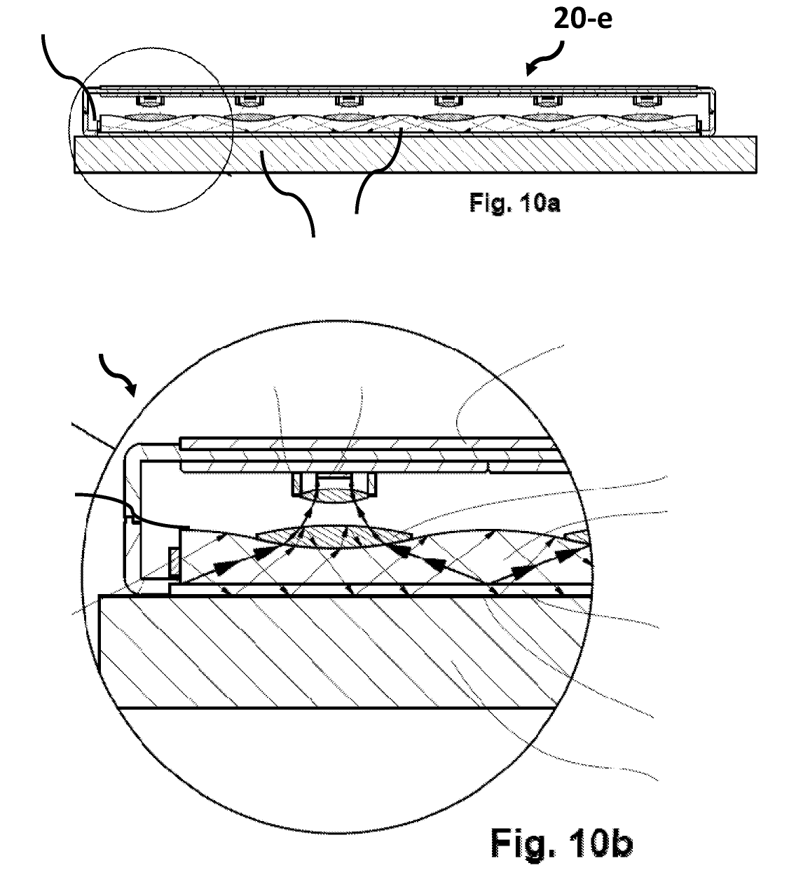

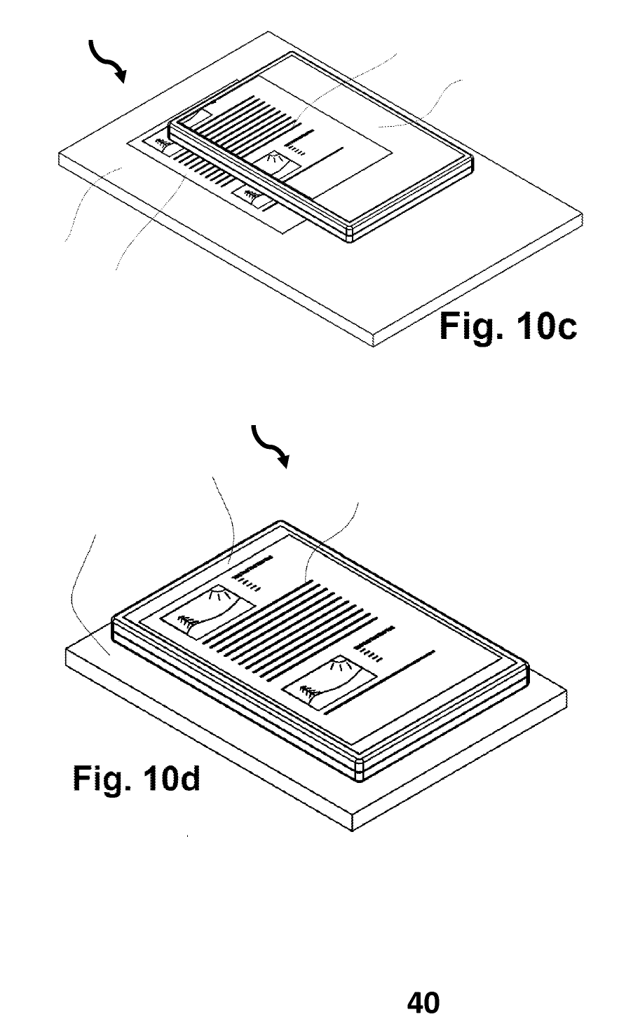

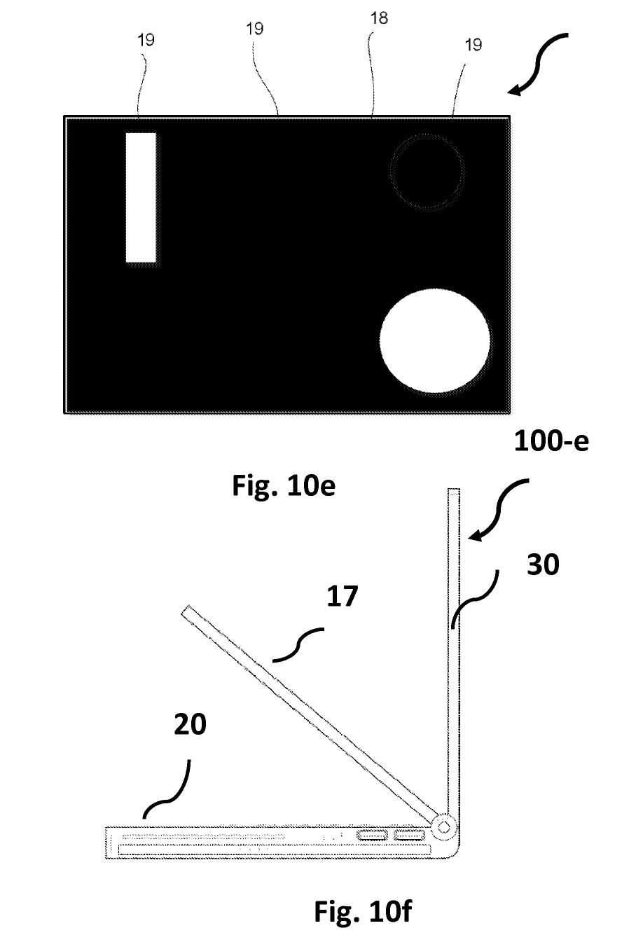

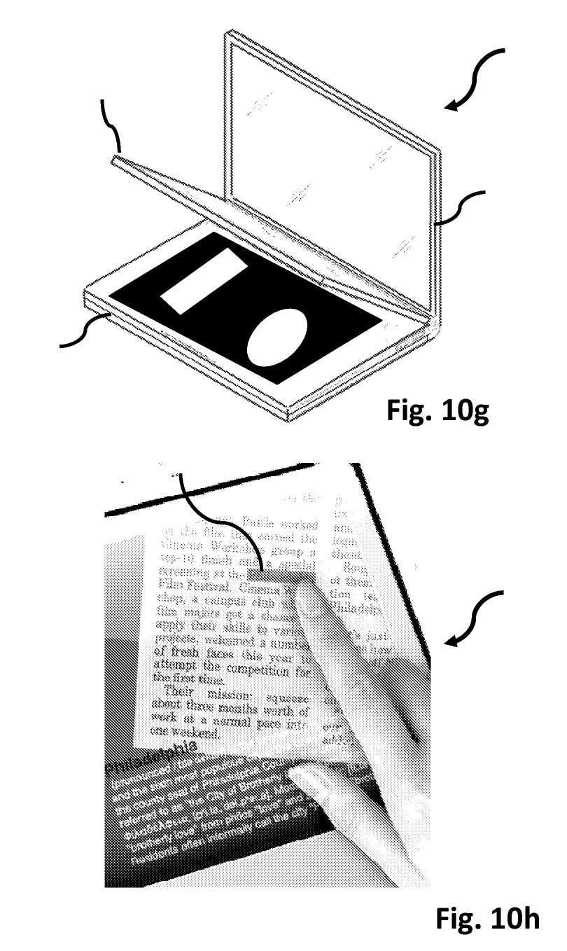

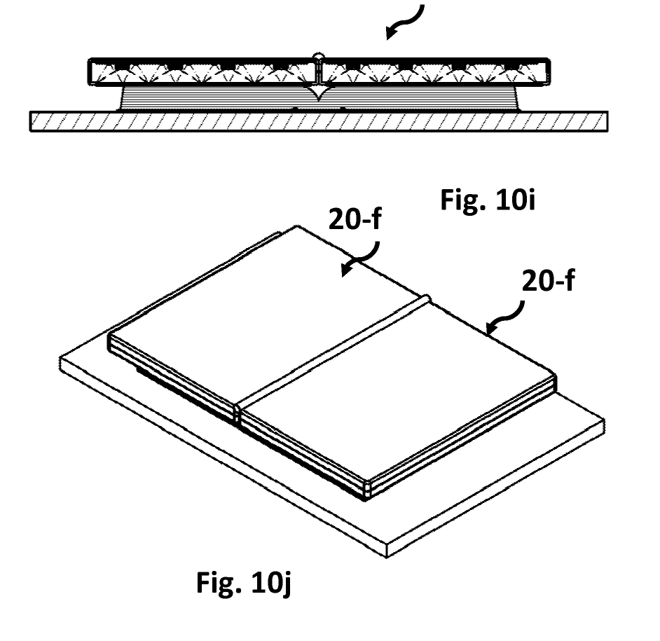

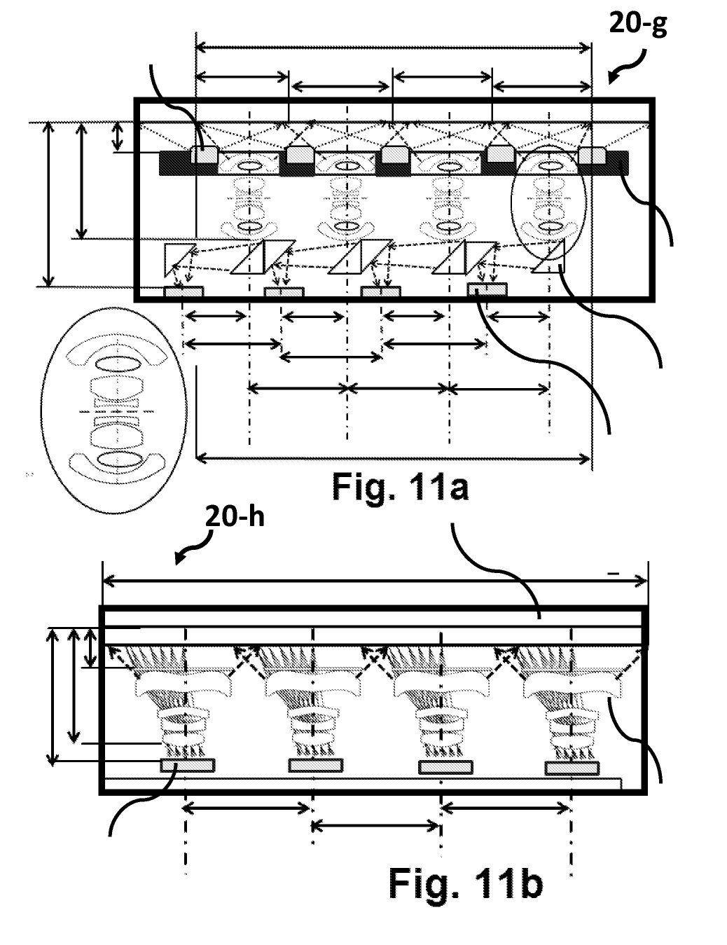

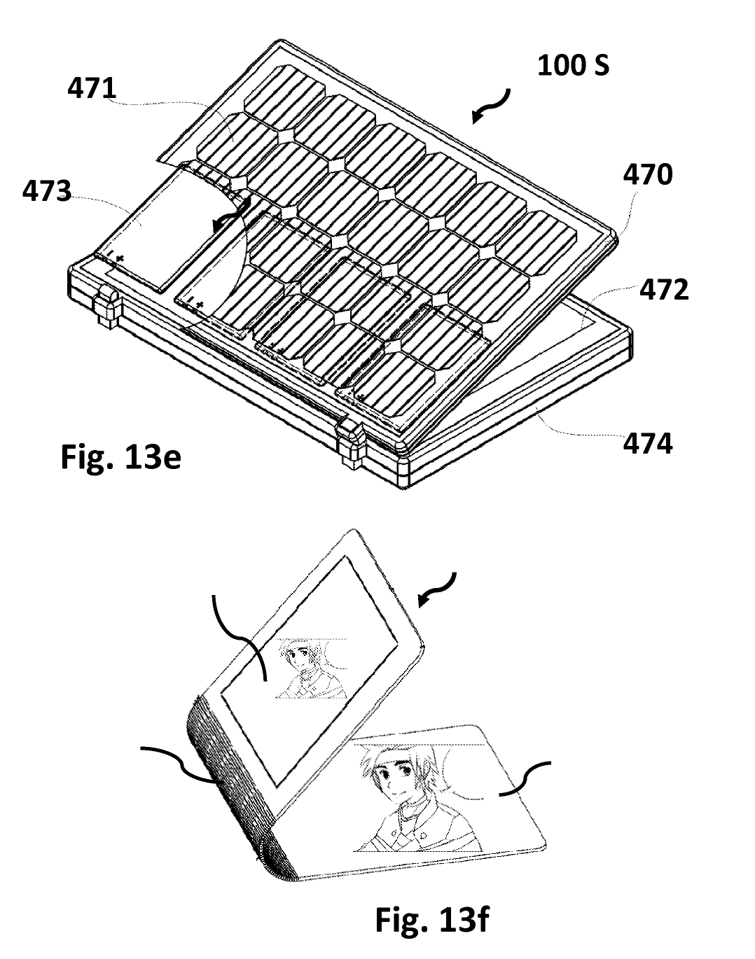

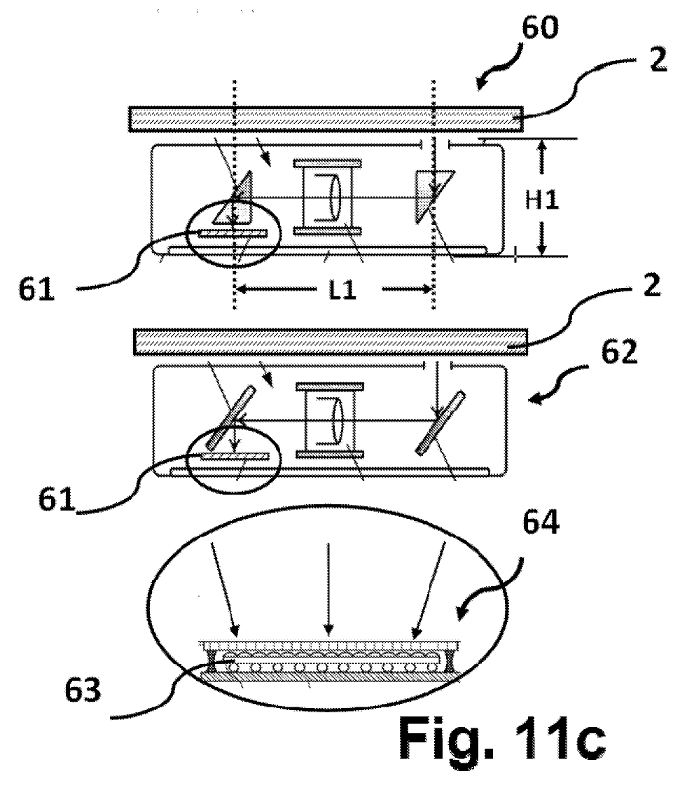

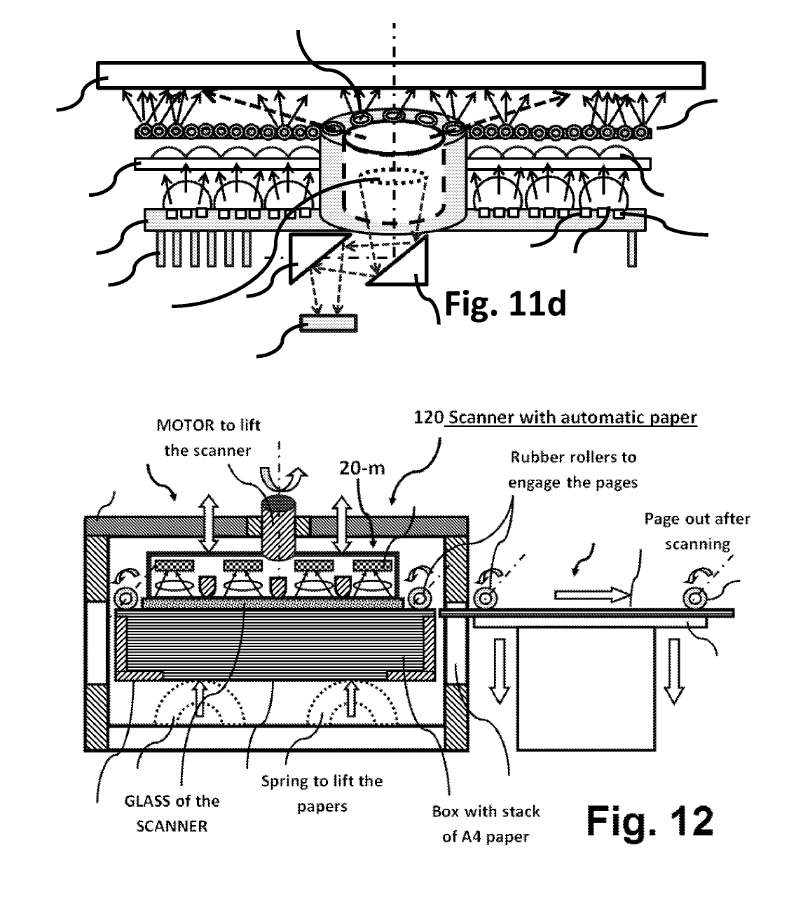

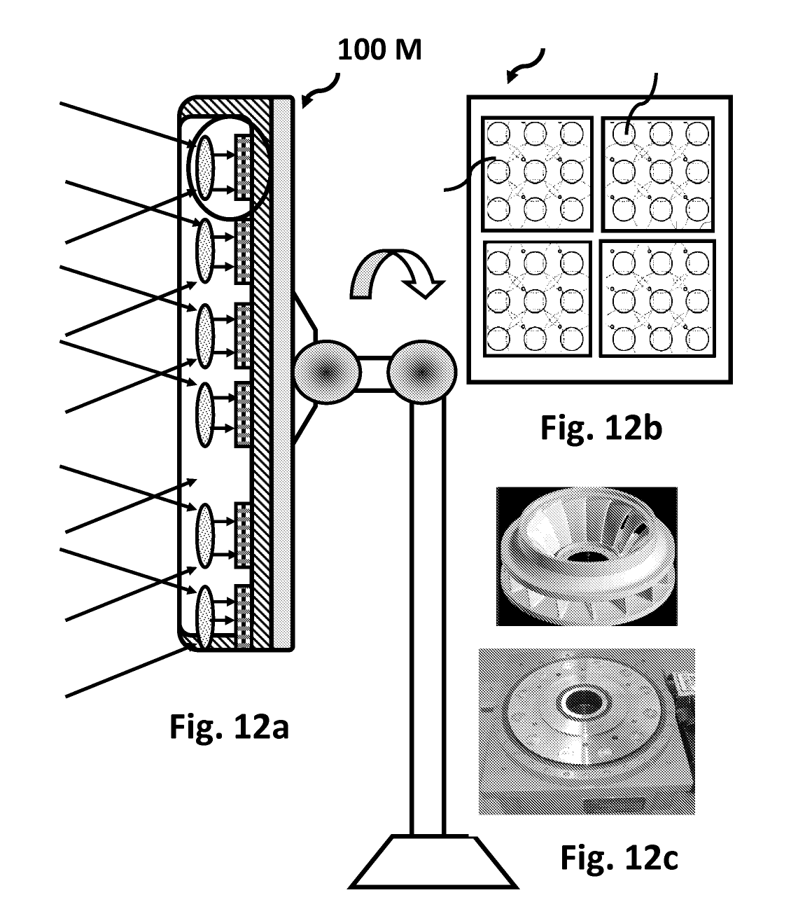

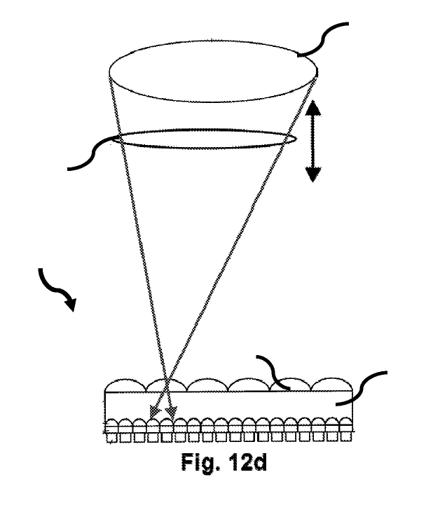

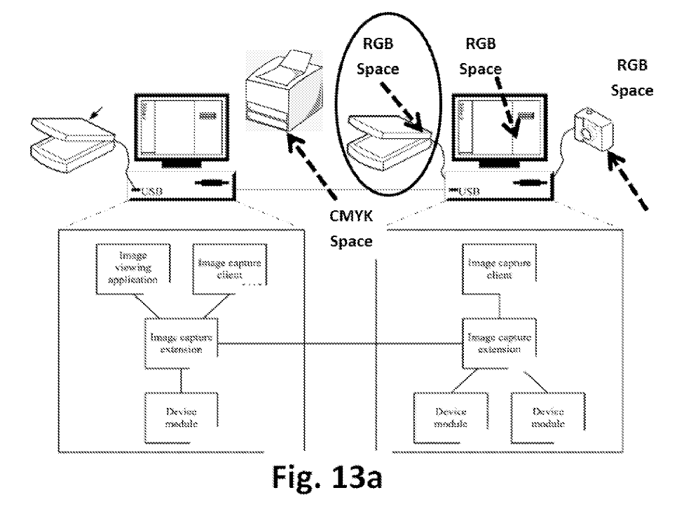

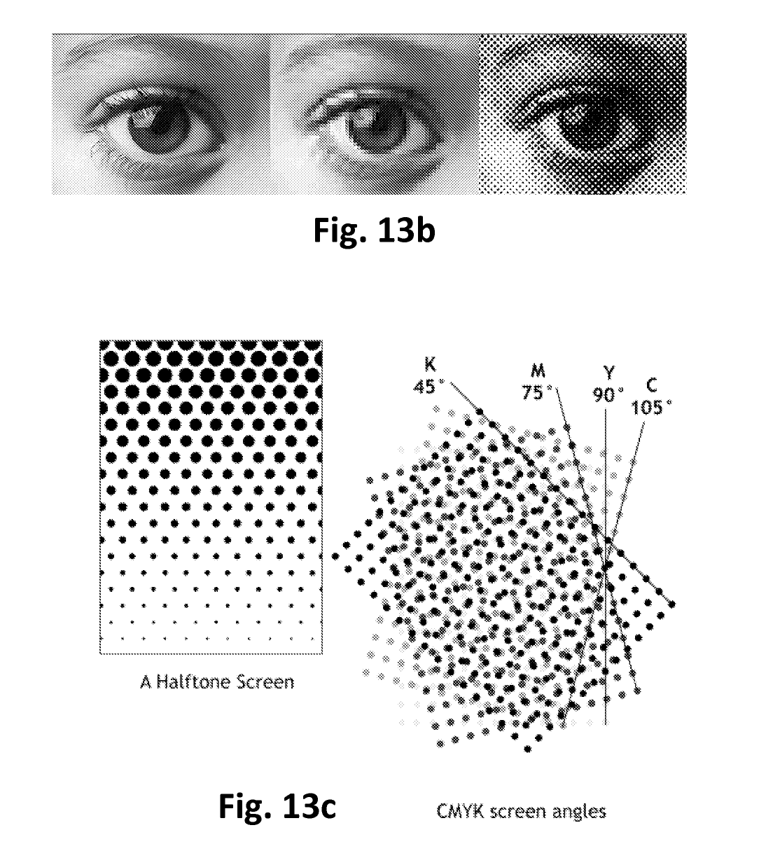

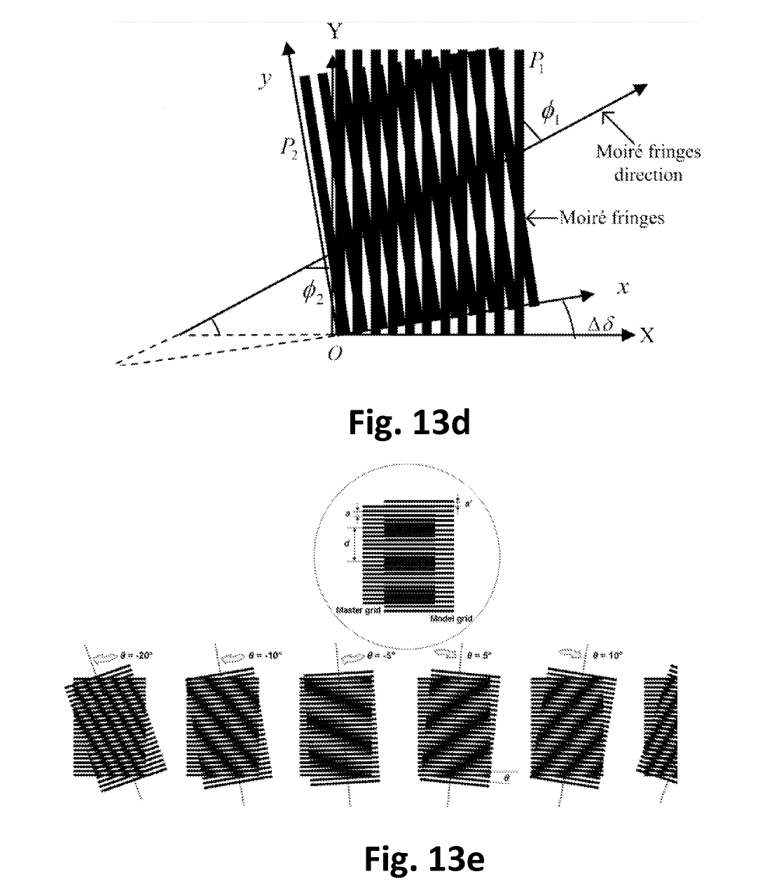

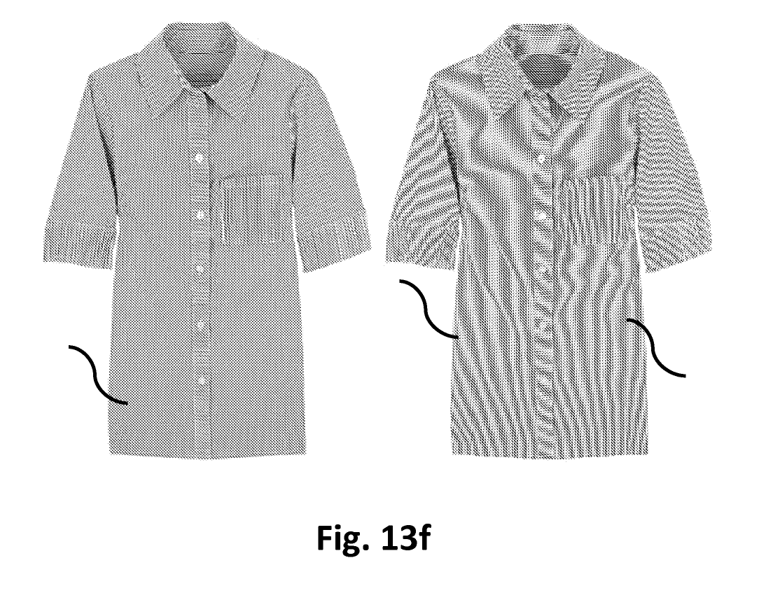

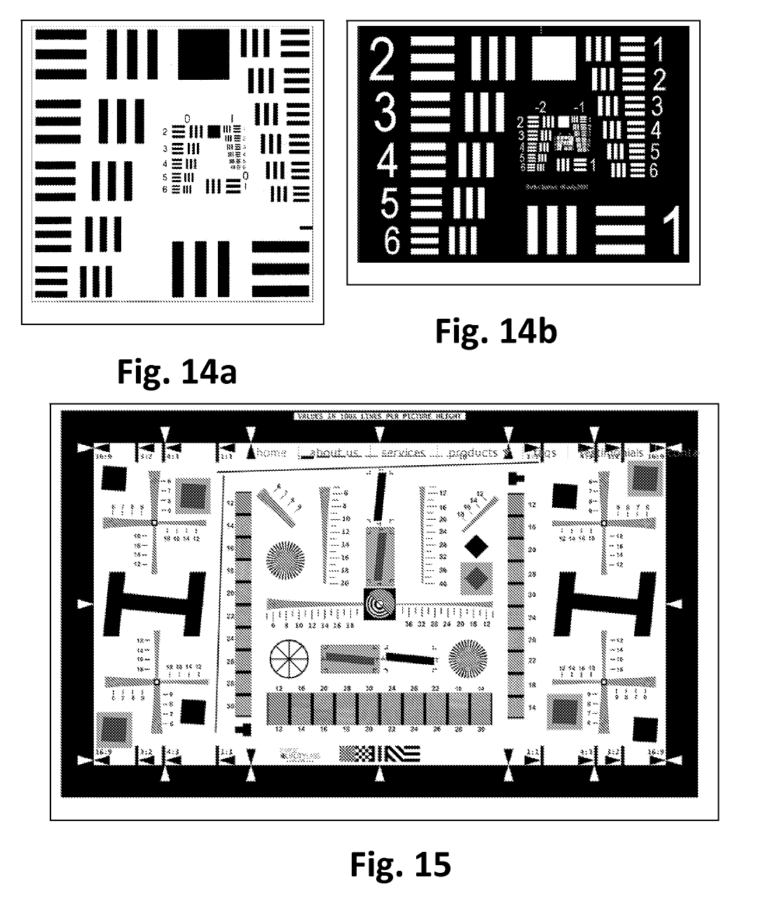

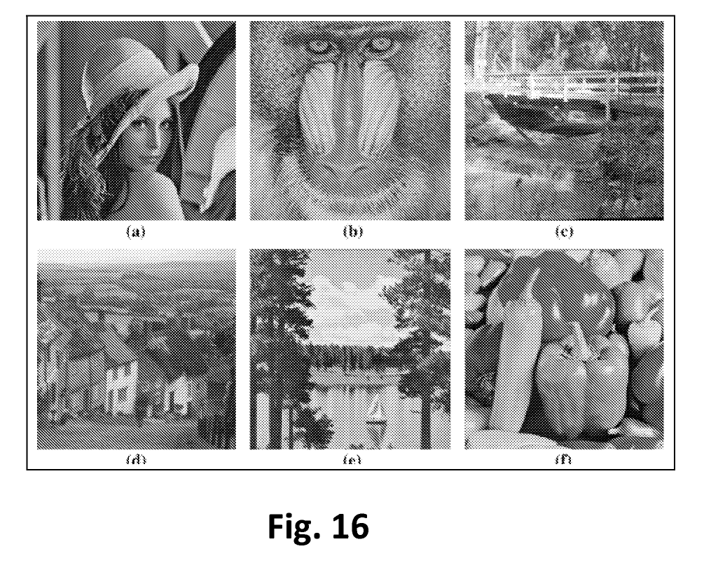

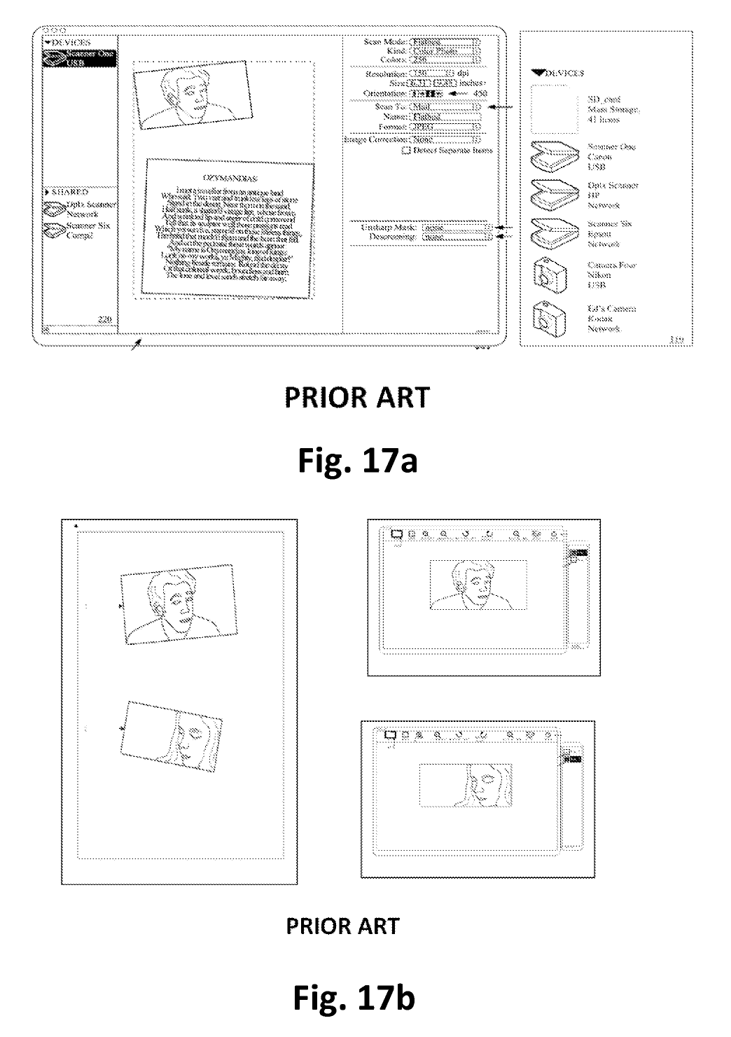

FIGS. 1-2 show several design options for the image capturing lenses, for the illumination and for the image sensors that can be CCDs and LEDs.

The illumination can be done with RGB LEDS or OLED illumination substrates. The OLED insure both a very compact size and the possibility to change the illumination spectrum.

Various lenses can be used with fix or variable focal planes.

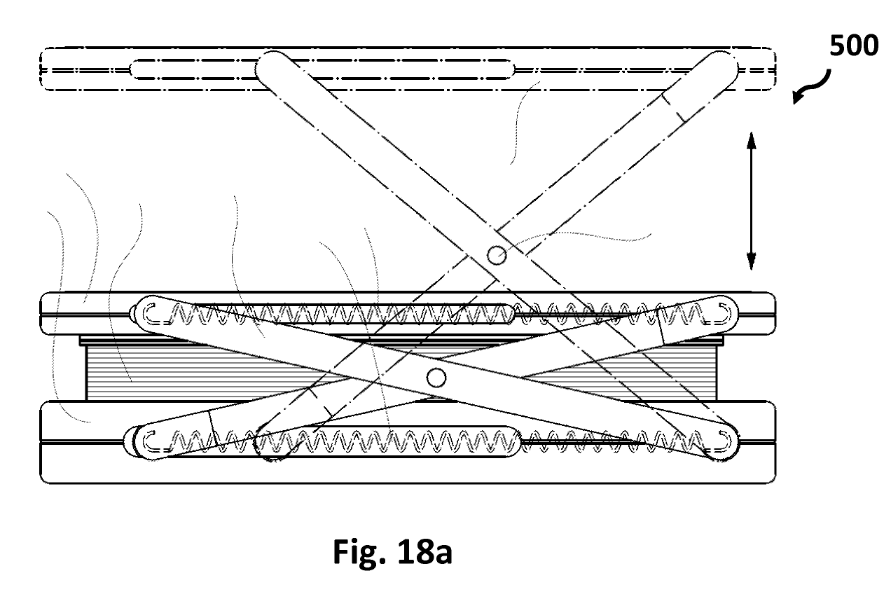

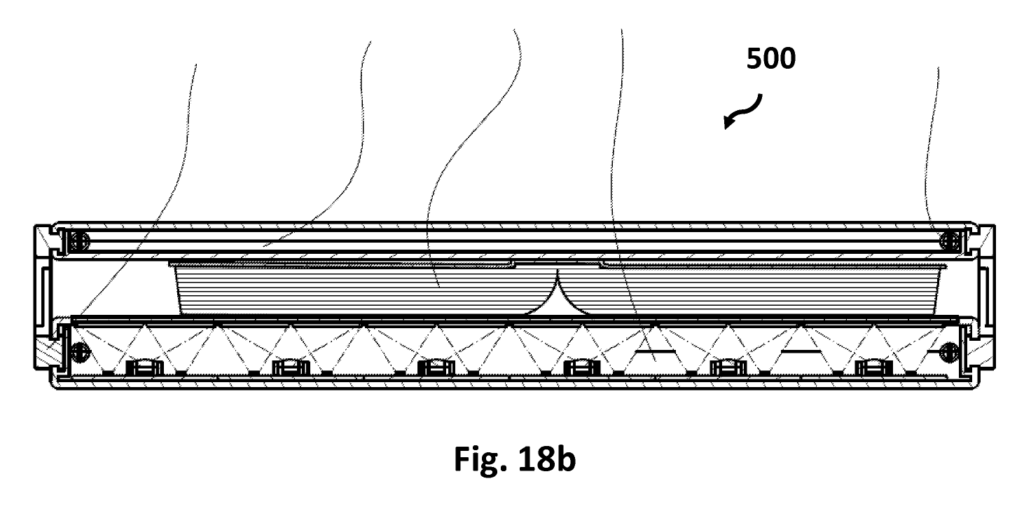

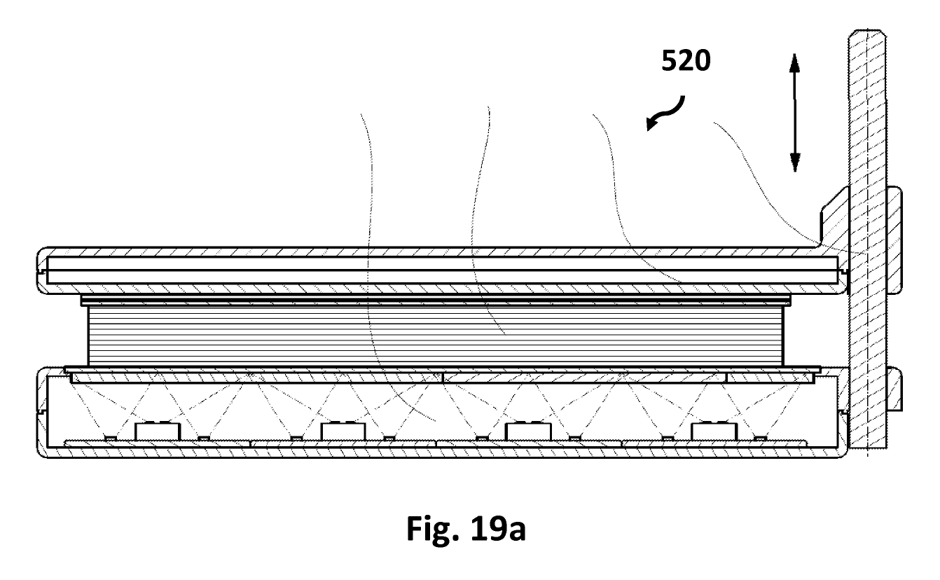

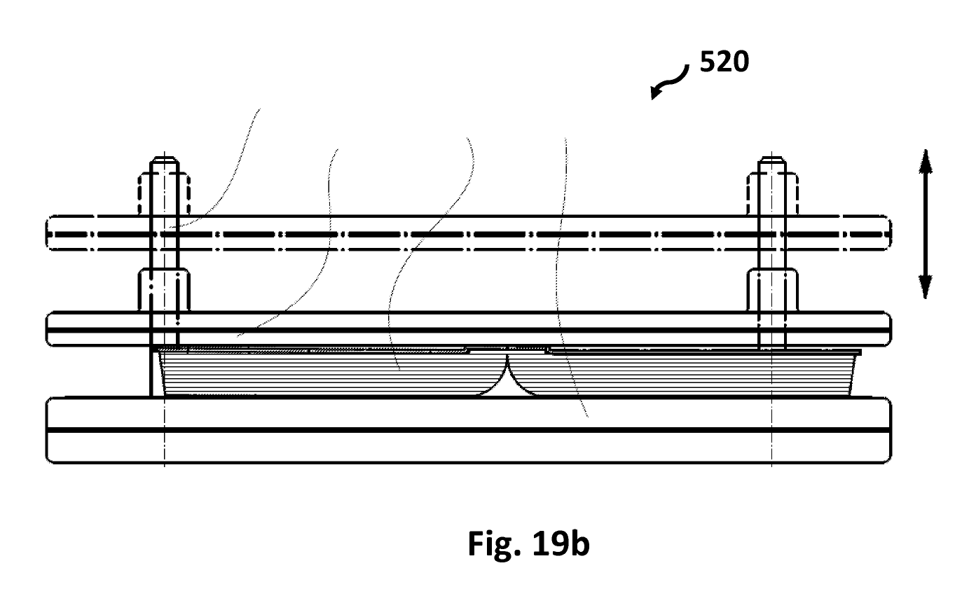

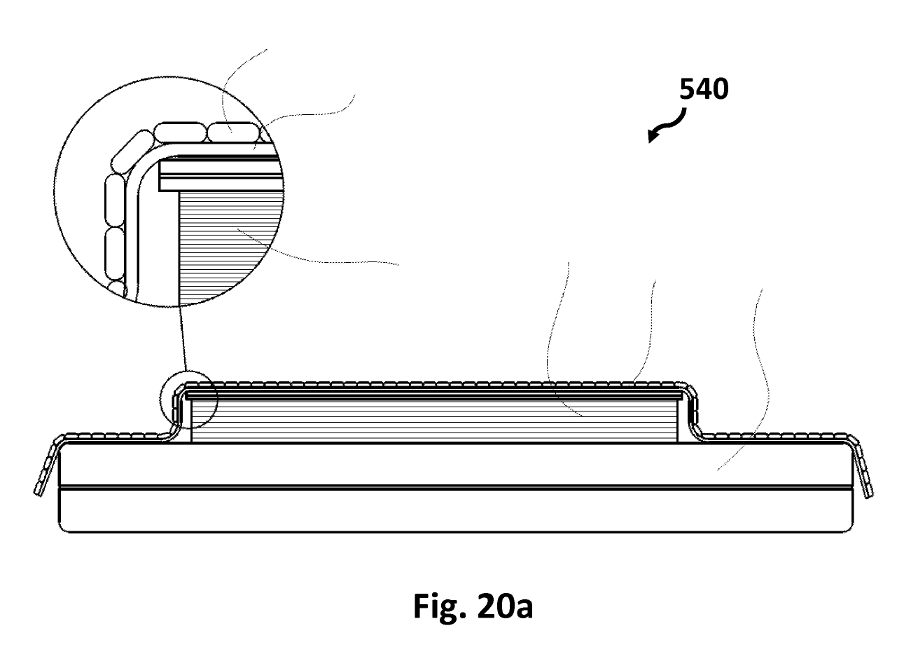

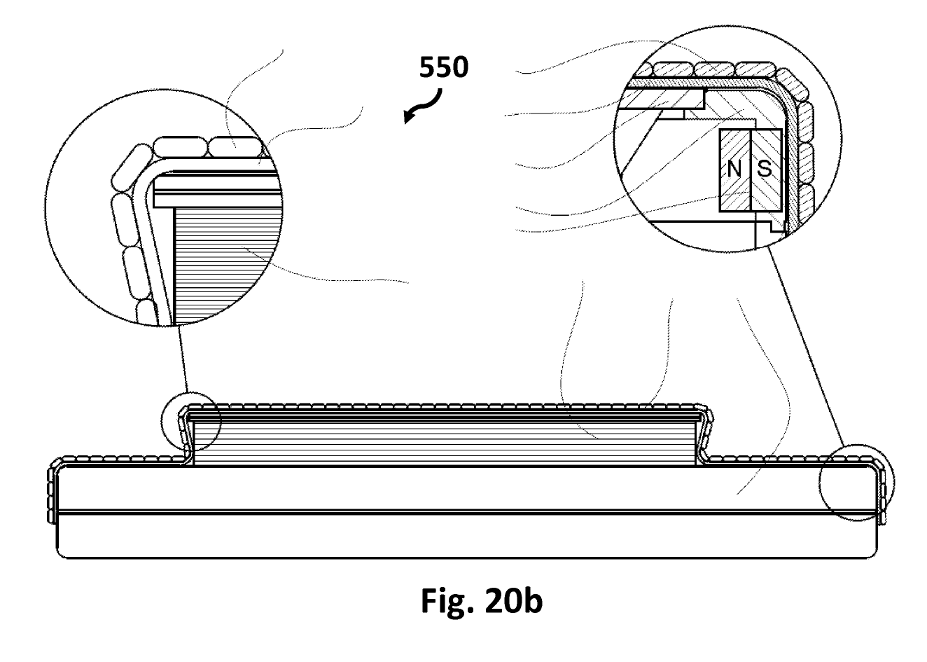

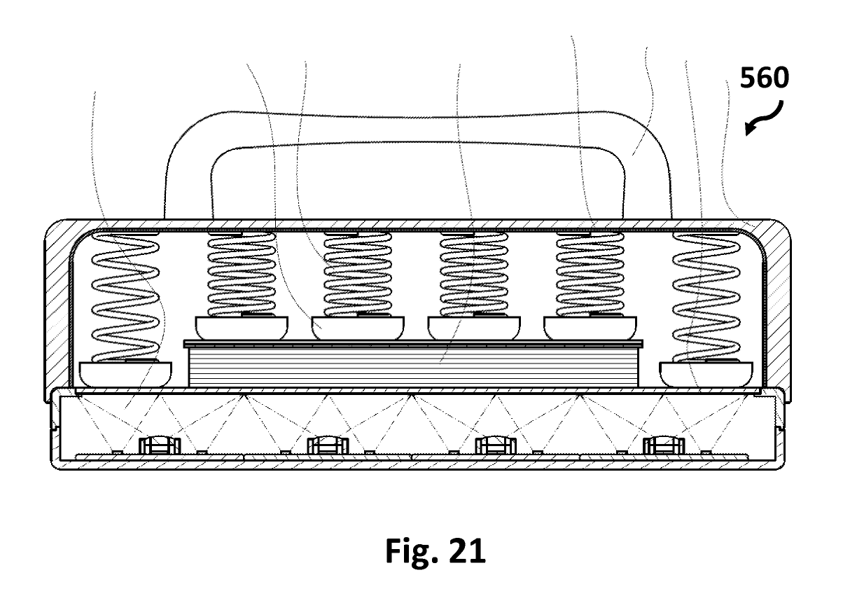

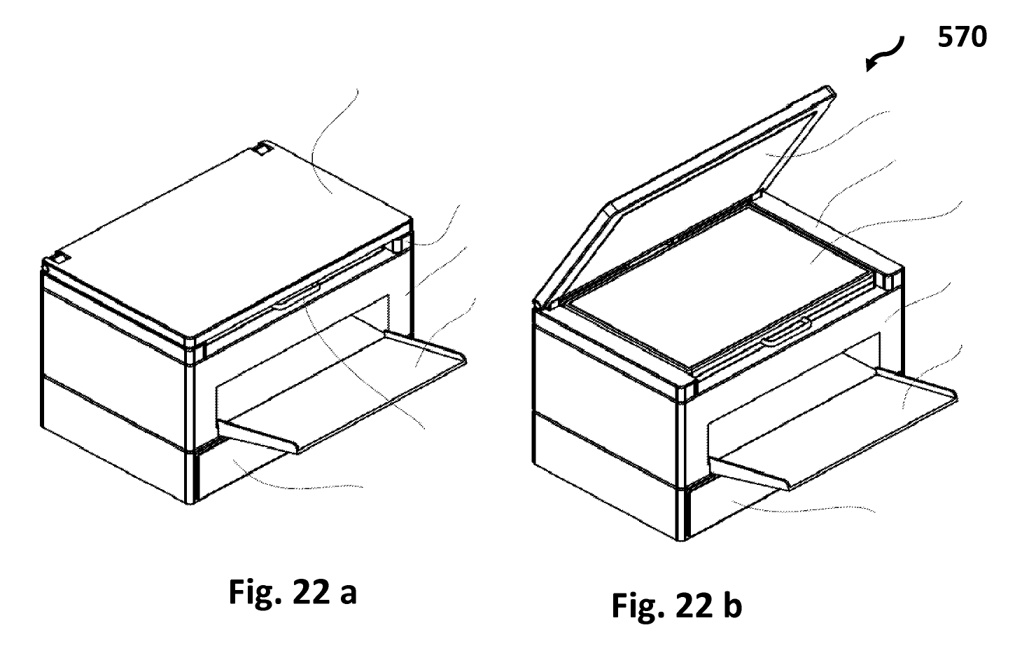

FIGS. 18 and 19 show an embodiment of the scanner copier where the cover translates vertically and parallel to the glass support to enable scanning of thicker documents and books.

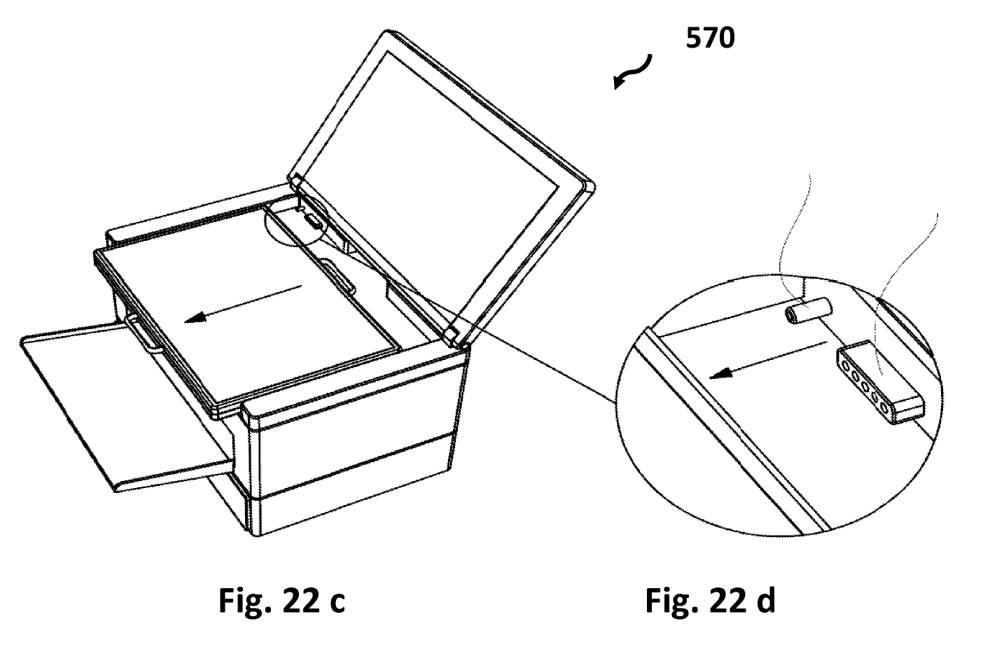

FIG. 22 show an embodiment where the scanner or copier according to this invention is removably coupled to a printer.

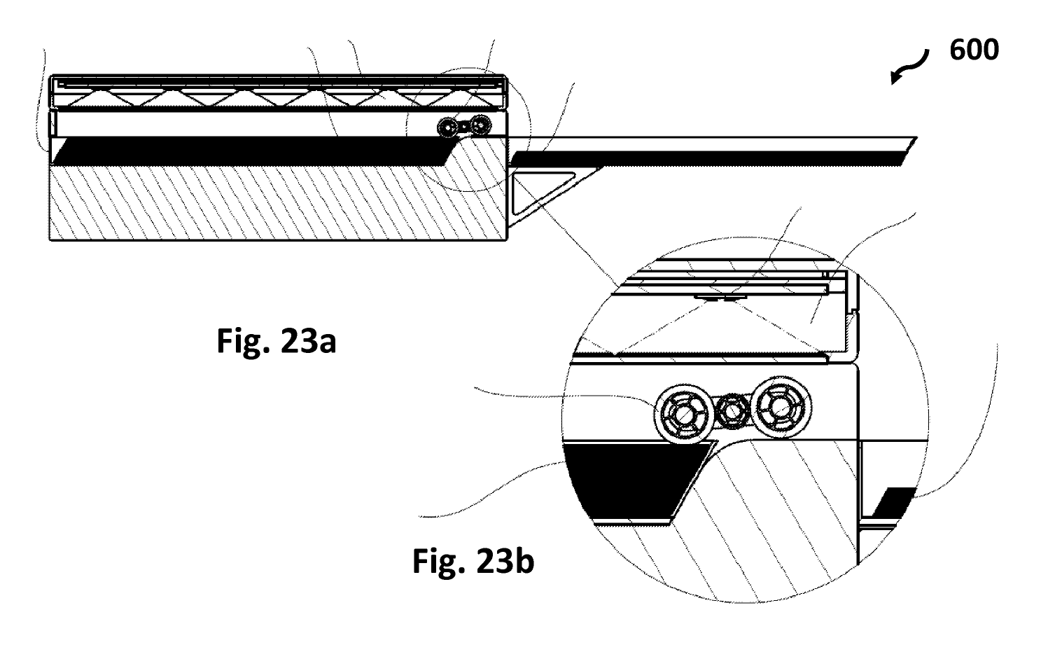

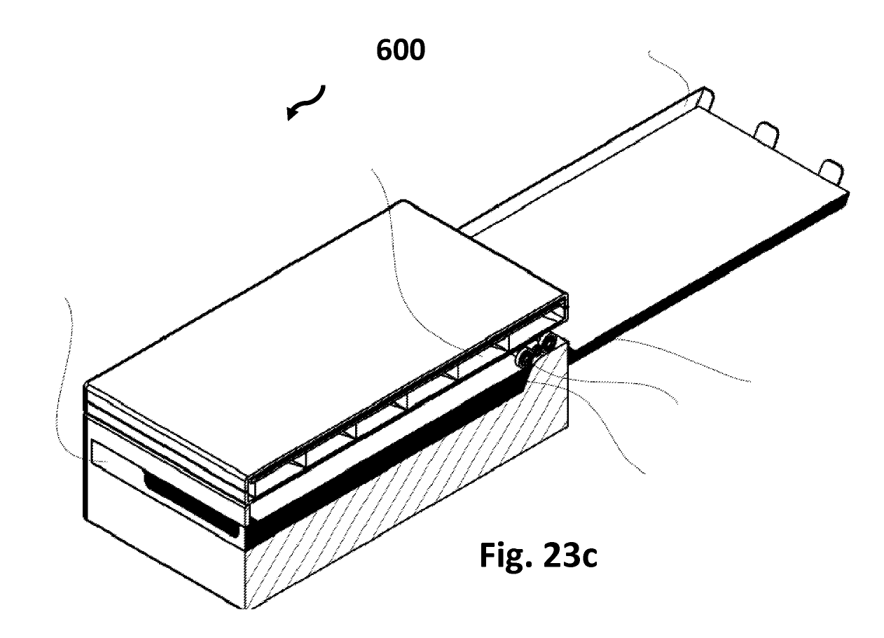

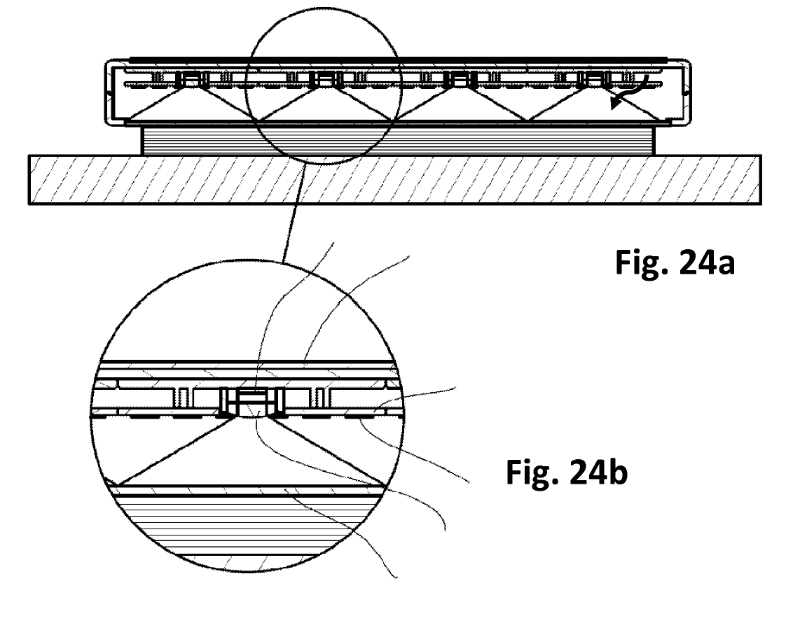

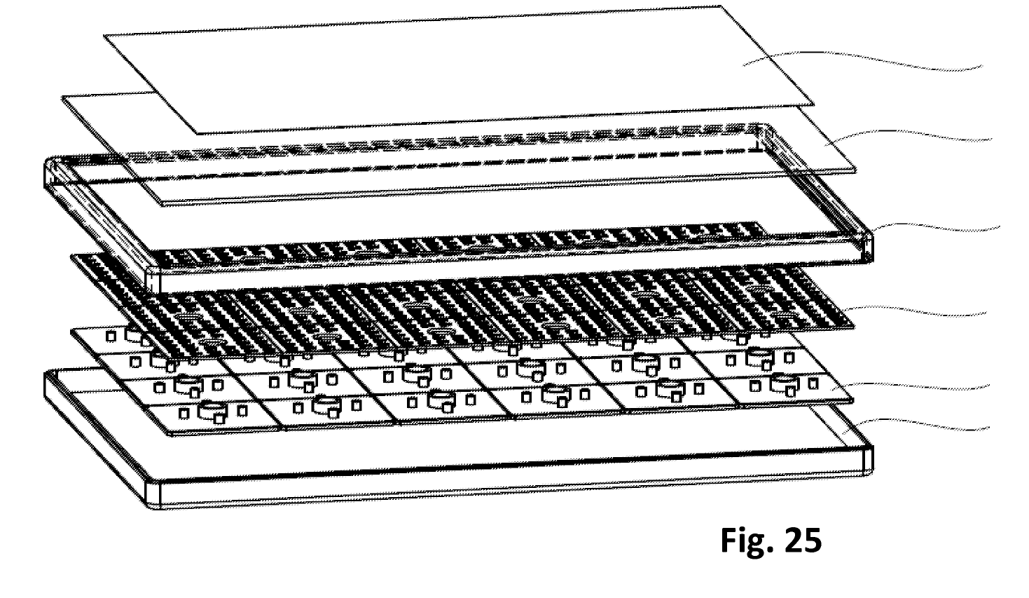

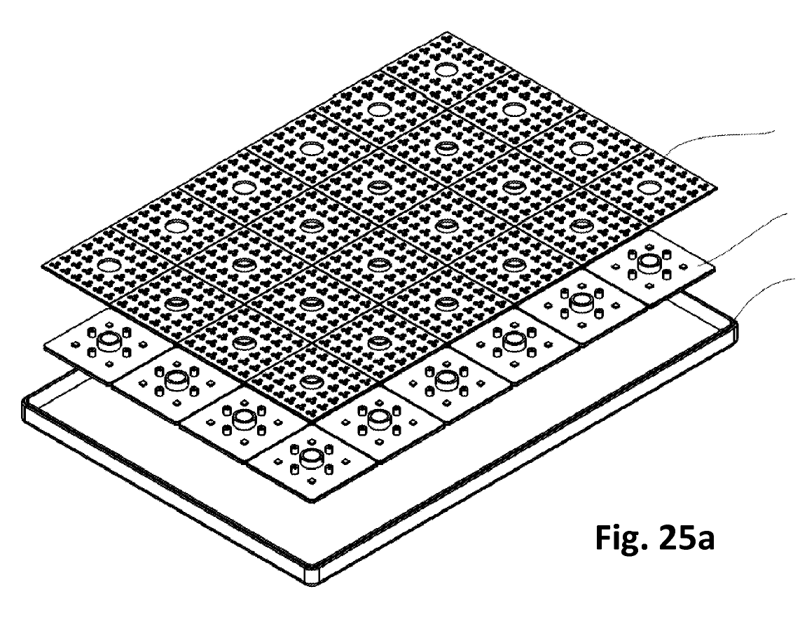

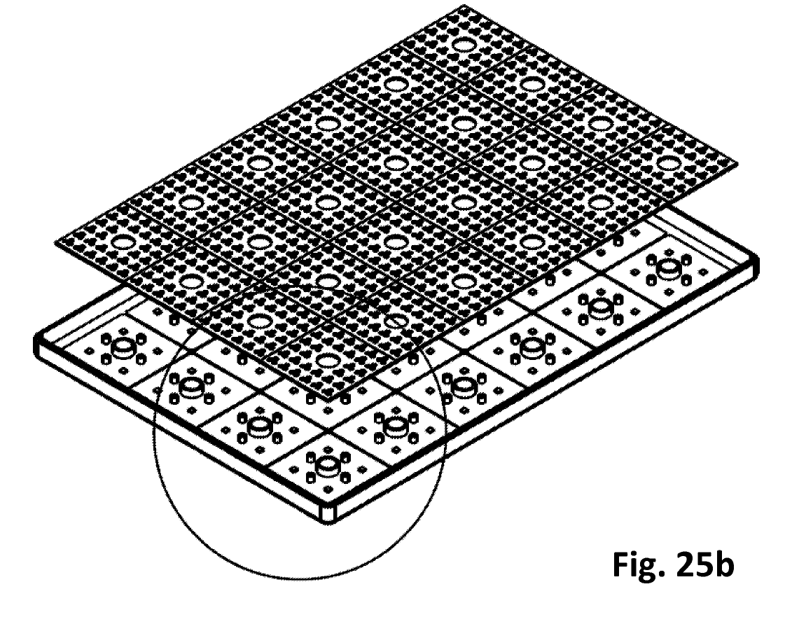

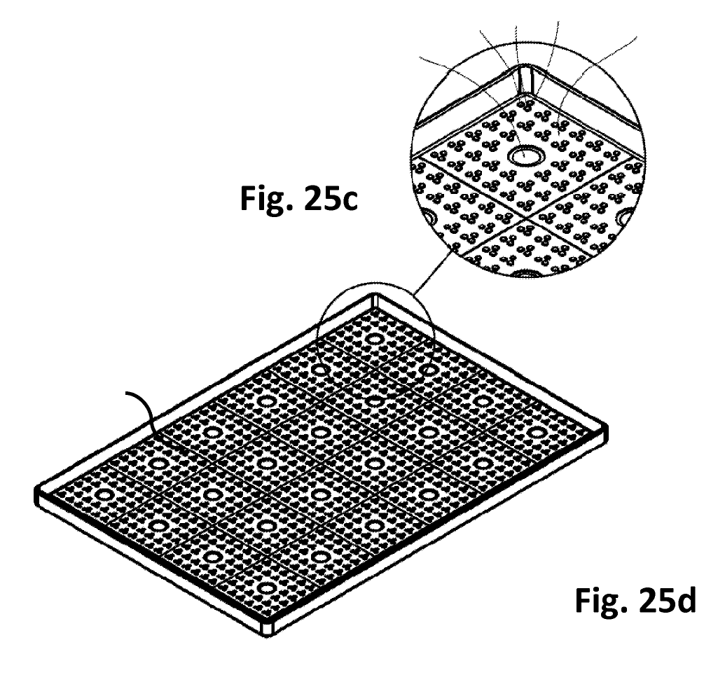

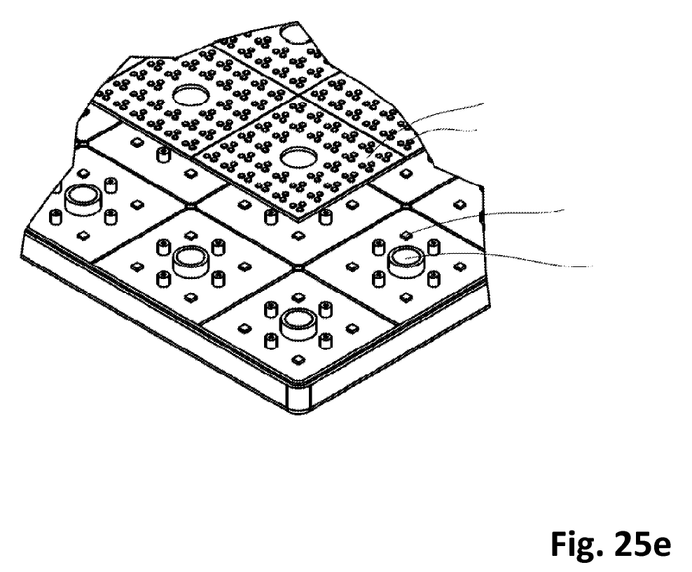

FIGS. 23 a-b-c show an embodiment of the scanner where a bunch of identical or different document can be scanned automatically and a transporting and gripping mechanism is used to remove each document from the scanning area and arrange each document automatically in a tray. iA color contact imaging device is used as a static scanner to capture the image of a document size A4 or A3. The document to be scanned can be a single page flat document or a bound book or magazine. The desktop static scanner is designed to work by direct contact with the document and has a modular and platform based configuration.

In several embodiments of the invention the contact static scanner includes a color imaging engine consisting of a static 2D array of area array monochromatic light sensors (such as CCDs and CMOS), a static 2D array of optical imaging elements and a static planar solid state illumination source matching the size of the document to be scanned, i.e. A4 or A3.

In several embodiments of the invention the planar illumination source is also quite thin and is positioned either at the level of an entrance aperture of the optical imaging elements or above the optical imaging elements. In both cases the planar illumination source is configured to create a uniform light intensity pattern onto the document to be captured without any shading caused by the optical imaging elements and their mechanical support.

In several embodiments of the invention key elements of the color imaging engine are removable and replaceable with elements having different optical and color characteristics that are more suitable for a specific scanning job.

In several embodiments of the invention the design was made having in mind a platform based product where based on the need of the application the optics and illumination and the sensors can be selected based on pre-designed and pre-manufactured assemblies and modules.

In several embodiments of the invention a color calibration step is performed from time to time, or for some special jobs quite frequently, to create and store a light distribution profile of the scanner on a specific date. The intensity distribution is captured using a target that best matches the paper or other substrate of the object to be scanned and is stored in a look up table. A color correction and light intensity correction step can be performed for certain documents to make sure the captured image has the right color and the right intensity.

In several embodiments of the invention the planar illumination source is an OLED thin sheet that is configured to deliver either white or sequences of RGB and other colors

In several embodiments of the invention the planar illumination source is an OLED.

In several embodiments of the invention automatic feeding of several documents to be scanned is provided in a very compact design.

In several embodiments of the invention the illumination of the document is done using planar light guides in conjunction with RGB LEDs.

According to one aspect of the invention a contact type document scanner includes a static 2D array of lenses optically coupled to a static 2D array of color digital image sensors. A static light source dimensioned to match the surface of the document ensures a uniform illumination of the entire document. The entire document or any desired portions of the document can be scanned and saved without any mechanical movements. This scanner also works in a video-camera mode and a display is used to pre-proof and visualize live any image portions or the entire document before the image of the document is saved in a dedicated memory. The color balance and the position of the document and can be thus adjusted prior to scanning it by using its live image. An image segmentation mode is also available, where the display has a touch screen function coupled to the scanner that is used to select and or mask only some areas of the document that need to be scanned individually. This requires customized changes in the illumination and or image capturing. In one mode of operation, the scanner can be also fully used independently from a computer.

The contact type static scanner for image capturing of a document comprises:
An enclosure ( ) having an upper portion ( ) and a lower portion ( )
An optically transparent planar support ( ) to secure and position the document ( ) onto the upper portion ( ) of the enclosure ( ), the planar support ( ) defining an object plane ( );
A stationary 2D array of identical lenses ( ), where each lens ( ) is coupled directly or indirectly to the enclosure ( ), each lens ( ) being positioned at the same level relative to the transparent planar support ( ), wherein each individual lens ( ) is located and is designed/capable/adapted to capture a corresponding image portion of the document ( ) and where all the lenses ( ) of the 2D array are located and designed/capable/adapted to capture at once and simultaneously a full image of the document ( );
A stationary 2D array of identical digital color image sensors ( ), where each color image sensor ( ) is coupled directly or indirectly to the enclosure ( ), the color image sensors defining an image plane ( ) and where each color image sensor ( ) having an area array of light responsive pixels ( ), the pixels ( ) being arranged orderly or randomly ( );
A stationary light source ( ) positioned adjacent the lenses ( ) coupled directly or indirectly to the enclosure ( ), the light source ( ) being designed/capable/adapted to illuminate at once a) either a portion of the document ( ), or b) several spaced apart portions of the document ( ) or c) the entire surface of the document ( );
An image processing unit ( ) receiving image data from the color image sensors ( ), the image processing unit ( ) being coupled directly or indirectly to the enclosure ( ), the image processing unit ( ) being designed/capable/adapted to re-construct a full image of the document ( ) from the partial images captured by the individual lenses ( ) and sensors ( );
A memory ( ) coupled directly or indirectly to the enclosure ( ), the memory ( ) being designed/capable/adapted to store at once a) either a portion of the document ( ), or b) several spaced apart portions of the document ( ) or c) the entire document ( );
A touch screen image display ( ) connectable to the enclosure ( ), the image display ( ) being located and being designed/capable/adapted to visualize a portion, a plurality of portions or the entire document before and after the portion, or the portions or the entire document have been stored in the memory ( ) and where the position of the document ( ) can be adjusted prior to capturing and saving an image of the document ( ) while observing the image of the document ( ) on the display ( ) to ensure a proper positioning of the document relative to the 2D array of lenses.
A processor ( ) coupled directly or indirectly to the enclosure ( ) designed/capable/adapted to operate the scanner during each step required to capture the image of the document and manipulate the image of the document independently from any remote device.

The contact type static scanner for image capturing of a document comprises:
An enclosure ( ) having an upper portion ( ) and a lower portion ( )
An optically transparent planar support ( ) to secure and position the document ( ) onto the upper portion ( ) of the enclosure ( ), the planar support ( ) defining an object plane ( );
A stationary 2D array of identical lenses ( ), where each lens ( ) is coupled directly or indirectly to the enclosure ( ), each lens ( ) being positioned at the same level relative to the transparent planar support ( ), wherein each individual lens ( ) is located and is designed/capable/adapted to capture a corresponding image portion of the document ( ) and where all the lenses ( ) of the 2D array are located and designed/capable/adapted to capture at once and simultaneously a full image of the document ( );
A stationary 2D array of identical digital color image sensors ( ), where each color image sensor ( ) is coupled directly or indirectly to the enclosure ( ), the color image sensors defining an image plane ( ) and where each color image sensor ( ) having an area array of light responsive pixels ( ), the pixels ( ) being arranged orderly or randomly ( );
A stationary light source ( ) positioned adjacent the lenses ( ) coupled directly or indirectly to the enclosure ( ), the light source ( ) being designed/capable/adapted to illuminate at once a) either a portion of the document ( ), or b) several spaced apart portions of the document ( ) or c) the entire surface of the document ( );
An image processing unit ( ) receiving image data from the color image sensors ( ), the image processing unit ( ) being coupled directly or indirectly to the enclosure ( ), the image processing unit ( ) being designed/capable/adapted to re-construct a full image of the document ( ) from the partial images captured by the individual lenses ( ) and sensors ( );
A memory ( ) coupled directly or indirectly to the enclosure ( ), the memory ( ) being designed/capable/adapted to store at once a) either a portion of the document ( ), or b) several spaced apart portions of the document ( ) or c) the entire document ( );
A touch screen image display ( ) connectable to the enclosure ( ), the image display ( ) being located and being designed/capable/adapted to visualize a portion, a plurality of portions or the entire document before and after the portion, or the portions or the entire document have been stored in the memory ( ) and where the position of the document ( ) can be adjusted prior to capturing and saving an image of the document ( ) while observing the image of the document ( ) on the display ( ) to ensure a proper positioning of the document relative to the 2D array of lenses.
A processor ( ) coupled directly or indirectly to the enclosure ( ) designed/capable/adapted to operate the scanner during each step required to capture the image of the document and manipulate the image of the document solely via instructions received from the touch screen display.

The contact type static scanner where the illumination source is a single planar luminescent sheet ( ) coupled directly or indirectly to the enclosure ( ), the single planar luminescent sheet ( ) having an active illumination surface area ( ) substantially matching in size the surface area of the document to be scanned or the effective area of the transparent support;

A contact type static scanner where the illumination source consists of at least two planar luminescent sheets ( )

A portable image capturing apparatus of a document according to claim 1 where the illumination source consists of a planar OLED or AMOLED luminescent sheet ( )

A portable image capturing apparatus of a document where the illumination source is a 2D array of LEDs, each LED being adjacent.

What is claimed is:

1. A portable desktop image processor configured to opearte as a color scanner or a color copier comprising:
a housing having a planar front section, an opposite back section, and a plurality of lateral sections defing a height of the housing;
a planar window element ( ) coupled to the front section of the housing and having a transparent front surface ( ) and a transparent opposite back surface ( ), the planar window being made of a material having a first refractive index, the planar window defing an optical object plane;
a stationary two-dimensional array of imaging elements within the housing, wherein each of the imaging element is configured to capture a portion of a document imaging area contacting the window element ( ) and wherein the imaging elements are equally spaced relative to each other to capture the entire document imaging area, and where the imaging elements are coupled to the housing via i) individual support elements or ii) a common support element;
a stationary two-dimensional array of area array image sensor elements within the housing, the image sensor elements defining an optical image plane that is parallel to the optical object plane, the image sensor elements comprising visible light responsive pixels arranged orderly or randomly relative to one another, where the image sensor elements are coupled to the imaging elements via i) individual support elements or ii) a common support element and where the image sensor elements are coupled to the housing via i) individual support elements or ii) a common support element;
a planar and stationary illumination source within the housing, wherein the illumination source is coupled to a controller ( ) configured to provide at least two illumination functions to the illumination source, the illumination functions being i) illuminate a single portion of the document imaging area or illuminate the entire imaging area, and where the illumination source includes a plurality of discrete clusters of R-G-B lighting elements ( ) positioned adjacent each imaging lens ( ), the R-G-B lighting elements ( ) being adapted to operate
i) simultaneously, to create a substantially white illumination pattern of the document during a single illumination exposure ( ) captured by the image sensors ( ), or
ii) sequentially, to create individual R-G-B illumination patterns of the document during three illumination exposures ( ) each captured separately by the image sensors ( ), or
iii) sequentially and in pairs to create individual RG-RB-BG illumination patterns of the document during three illumination exposures ( ) each captured separately by the image sensors ( )
a stationary planar support coupled to the planar front section to secure and position a document for imaging;
wherein the portable desktop imaging processor is capable of capturing a full image or a partial image of the document via a mecahnically static optical and digital imaging process and is capable of being positioned on top of or below the document for the imaging process.

2. The portable desktop imaging processor of claim 1, wherein the image processor is coupled to an image memory to store one or more of i) a single portion of the document imaging area, ii) a plurality adjacent or non-adjacent portions of the document imaging area, and iv) all of the portions of the document imaging area.

3. The portable desktop imaging processor of claim 1, wherein the image processor is coupled to an image processing unit that reconstructs an image of the entire document or a partial image of the document based on the portions of the document imaging area captured by the imaging lenses and the image sensors.

4. The portable desktop imaging processor of claim 1, wherein the image processor is coupled to an operating system to improve the quality and position of the image of the document.

5. The portable desktop imaging processor of claim 2, further comprising a display connectable to the housing and being configured to function in a first mode as a video camera display to visualize one or more portions of the document before the one or more portions are stored in the image memory.

6. The portable imaging processor of claim 5, wherein the display provides for adjustment of the position of the document relative to the imaging lenses prior to imaging.

7. The portable imaging processor of claim 1, wherein the portable imaging processor is configured to perform image scanning via direct contact with the document.

8. The portable imaging processor of claim 7, wherein imaging processor is sized and shaped to be user-manipulated, including rotated upside down, to accommodate imaging a range of documents including i) a single page document, ii) a bound book, and iii) a bound magazine without an image noise generated by curved portions of a document.

9. A thin desktop image processor comprising:
a housing having a planar front section, an opposite back section, and a plurality of lateral sections defing a height of the housing that is sized and shaped so as to be user-manipulable, including rotated upside down, to accommodate imaging a range of documents including i) a single page document, ii) a bound book, and iii) a bound magazine without an image noise generated by curved portions of a document
a stationary two-dimensional array of imaging lenses within the housing, wherein each of the imaging lenses is configured to capture a portion of a document imaging area and wherein the imaging lenses are spaced relative to each other to capture the entire document imaging area;
a stationary two-dimensional array of color image sensors within the housing, the color image sensors defining an image plane and comprising light responsive pixels;
a stationary light source within the housing, wherein the light source is configured to illuminate i) a single portion of the document imaging area, ii) a plurality adjacent or non-adjacent portions of the document imaging area, and iv) all of the portions of the document imaging area; and
a stationary planar support coupled to the planar front section to secure and position a document for imaging;
wherein the portable desktop imaging processor is capable of capturing a full image or a partial image of the document via a mecahnically static optical and digital imaging process and is capable of being positioned on top of or below the document for the imaging process.

10. An image processing method comprising:
providing an image processing device;
receiving a signal indicative of a selection of one or more portions of a document to be imaged;
responsively causing the image processing device to illuminate, via a static light source, one or more portions of the document imaging area; and
responsively causing the image processing device to capture, via a plurality of static imaging lenses and static color imaging sensors, the selected one or more portions of the document.

11. The method of claim 10, further comprising:
displaying, via a video camera display, one or more portions of the document before the one or more portions are stored in an image memory.

12. A contact type static scanner for image capturing of a document comprising:
An enclosure ( ) having an upper portion ( ) and a lower portion ( )
An optically transparent planar support ( ) to secure and position the document ( ) onto the upper portion ( ) of the enclosure ( ), the planar support ( ) defining an object plane ( );
A stationary 2D array of identical lenses ( ), where each lens ( ) is coupled directly or indirectly to the enclosure ( ), each lens ( ) being positioned at the same level relative to the transparent planar support ( ), wherein each individual lens ( ) is located and is designed/capable/adapted to capture a corresponding image portion of the document ( ) and where all the lenses ( ) of the 2D array are located and designed/capable/adapted to capture at once and simultaneously a full image of the document ( );
A stationary 2D array of identical digital color image sensors ( ), where each color image sensor ( ) is coupled directly or indirectly to the enclosure ( ), the color image sensors defining an image plane ( ) and where each color image sensor ( ) having an area array of light responsive pixels ( ), the pixels ( ) being arranged orderly or randomly ( );
A stationary light source ( ) positioned adjacent the lenses ( ) coupled directly or indirectly to the enclosure ( ), the light source ( ) being designed/capable/adapted to illuminate at once a) either a portion of the document ( ), or b) several spaced apart portions of the document ( ) or c) the entire surface of the document ( );
An image processing unit ( ) receiving image data from the color image sensors ( ), the image processing unit ( ) being coupled directly or indirectly to the enclosure ( ), the image processing unit ( ) being designed/capable/adapted to re-construct a full image of the document ( ) from the partial images captured by the individual lenses ( ) and sensors ( );
A memory ( ) coupled directly or indirectly to the enclosure ( ), the memory ( ) being designed/capable/adapted to store at once a) either a portion of the document ( ), or b) several spaced apart portions of the document ( ) or c) the entire document ( );
A touch screen image display ( ) connectable to the enclosure ( ), the image display ( ) being located and being designed/capable/adapted to visualize a portion, a plurality of portions or the entire document before and after the portion, or the portions or the entire document have been stored in the memory ( ) and where the position of the document ( ) can be adjusted prior to capturing and saving an image of the document ( ) while observing the image of the document ( ) on the display ( ) to ensure a proper positioning of the document relative to the 2D array of lenses.
A processor ( ) coupled directly or indirectly to the enclosure ( ) designed/capable/adapted to operate the scanner during each step required to capture the image of the document and manipulate the image of the document independently from any remote device.

13. A contact type static scanner for image capturing of a document comprising:
An enclosure ( ) having an upper portion ( ) and a lower portion ( )
An optically transparent planar support ( ) to secure and position the document ( ) onto the upper portion ( ) of the enclosure ( ), the planar support ( ) defining an object plane ( );
A stationary 2D array of identical lenses ( ), where each lens ( ) is coupled directly or indirectly to the enclosure ( ), each lens ( ) being positioned at the same level relative to the transparent planar support ( ), wherein each individual lens ( ) is located and is designed/capable/adapted to capture a corresponding image portion of the document ( ) and where all the lenses ( ) of the 2D array are located and designed/capable/adapted to capture at once and simultaneously a full image of the document ( );
A stationary 2D array of identical digital color image sensors ( ), where each color image sensor ( ) is coupled directly or indirectly to the enclosure ( ), the color image sensors defining an image plane ( ) and where each color image sensor ( ) having an area array of light responsive pixels ( ), the pixels ( ) being arranged orderly or randomly ( );
A stationary light source ( ) positioned adjacent the lenses ( ) coupled directly or indirectly to the enclosure ( ), the light source ( ) being designed/capable/adapted to illuminate at once a) either a portion of the document ( ), or b) several spaced apart portions of the document ( ) or c) the entire surface of the document ( );
An image processing unit ( ) receiving image data from the color image sensors ( ), the image processing unit ( ) being coupled directly or indirectly to the enclosure ( ), the image processing unit ( ) being designed/capable/adapted to re-construct a full image of the document ( ) from the partial images captured by the individual lenses ( ) and sensors ( );
A memory ( ) coupled directly or indirectly to the enclosure ( ), the memory ( ) being designed/capable/adapted to store at once a) either a portion of the document ( ), or b) several spaced apart portions of the document ( ) or c) the entire document ( );
A touch screen image display ( ) connectable to the enclosure ( ), the image display ( ) being located and being designed/capable/adapted to visualize a portion, a plurality of portions or the entire document before and after the portion, or the portions or the entire document have been stored in the memory ( ) and where the position of the document ( ) can be adjusted prior to capturing and saving an image of the document ( ) while observing the image of the document ( ) on the display ( ) to ensure a proper positioning of the document relative to the 2D array of lenses.
A processor ( ) coupled directly or indirectly to the enclosure ( ) designed/capable/adapted to operate the scanner during each step required to capture the image of the document and manipulate the image of the document solely via instructions received from the touch screen display.

14. A contact type static scanner according to claim 1 where the illumination source is a single planar luminescent sheet ( ) coupled directly or indirectly to the enclosure ( ), the single planar luminescent sheet ( ) having an active illumination surface area ( ) substantially matching in size the surface area of the document to be scanned or the effective area of the transparent support;

15. A contact type static scanner according to claim 1 where the illumination source consists of at least two planar luminescent sheets ( )

16. A portable image capturing apparatus of a document according to claim 1 where the illumination source consists of a planar OLED or AMOLED luminescent sheet ( )

17. A portable image capturing apparatus of a document according to claim 1 where the illumination source is a 2D array of LEDs, each LED being adjacent;

18. A portable desktop image processor configured to opearte as a color scanner or a color copier comprising:
a housing having a planar front section, an opposite back section, and a plurality of lateral sections defing a height of the housing;
a planar window element ( ) coupled to the front section of the housing and having a transparent front surface ( ) and a transparent opposite back surface ( ), the planar window being made of a material having a first refractive index, the planar window defing an optical object plane;
a stationary two-dimensional array of imaging elements within the housing, wherein each of the imaging element is configured to capture a portion of a document imaging area contacting the window element ( ) and wherein the imaging elements are equally spaced relative to each other to capture the entire document imaging area, and where the imaging elements are coupled to the housing via i) individual support elements or ii) a common support element;
a stationary two-dimensional array of area array image sensor elements within the housing, the image sensor elements defining an optical image plane that is parallel to the optical object plane, the image sensor elements comprising visible light responsive pixels arranged orderly or randomly relative to one another, where the image sensor elements are coupled to the imaging elements via i) individual support elements or ii) a common support element and where the image sensor elements are coupled to the housing via i) individual support elements or ii) a common support element;
a planar and stationary illumination source within the housing, wherein the illumination source is coupled to a controller ( ) configured to provide at least two illumination functions to the illumination source, the illumination functions being i) illuminate a single portion of the document imaging area or illuminate the entire imaging area, and where the illumination source includes a plurality of discrete clusters of R-G-B lighting elements ( ) positioned adjacent each imaging lens ( ), the R-G-B lighting elements ( ) being adapted to operate
i) simultaneously, to create a substantially white illumination pattern of the document during a single illumination exposure ( ) captured by the image sensors ( ), or
ii) sequentially, to create individual R-G-B illumination patterns of the document during three illumination exposures ( ) each captured separately by the image sensors ( ), or
iii) sequentially and in pairs to create individual RG-RB-BG illumination patterns of the document during three illumination exposures ( ) each captured separately by the image sensors ( )
a stationary planar support coupled to the planar front section to secure and position a document for imaging;
wherein the portable desktop imaging processor is capable of capturing a full image or a partial image of the document via a mecahnically static optical and digital imaging process and is capable of being positioned on top of or below the document for the imaging process.

19. The portable desktop imaging processor of claim 1, wherein the image processor is coupled to an image memory to store one or more of i) a single portion of the document imaging area, ii) a plurality adjacent or non-adjacent portions of the document imaging area, and iv) all of the portions of the document imaging area.

20. The portable desktop imaging processor of claim 1, wherein the image processor is coupled to an image processing unit that reconstructs an image of the entire document or a partial image of the document based on the portions of the document imaging area captured by the imaging lenses and the image sensors.

21. The portable desktop imaging processor of claim 1, wherein the image processor is coupled to an operating system to improve the quality and position of the image of the document.

22. The portable desktop imaging processor of claim 2, further comprising a display connectable to the housing and being configured to function in a first mode as a video camera display to visualize one or more portions of the document before the one or more portions are stored in the image memory.

23. The portable imaging processor of claim 5, wherein the display provides for adjustment of the position of the document relative to the imaging lenses prior to imaging.

24. The portable imaging processor of claim 1, wherein the portable imaging processor is configured to perform image scanning via direct contact with the document.

25. The portable imaging processor of claim 7, wherein imaging processor is sized and shaped to be user-manipulated, including rotated upside down, to accommodate imaging a range of documents including i) a single page document, ii) a bound book, and iii) a bound magazine without an image noise generated by curved portions of a document.

26. A thin desktop image processor comprising:
a housing having a planar front section, an opposite back section, and a plurality of lateral sections defing a height of the housing that is sized and shaped so as to be user-manipulable, including rotated upside down, to accommodate imaging a range of documents including i) a single page document, ii) a bound book, and iii) a bound magazine without an image noise generated by curved portions of a document
a stationary two-dimensional array of imaging lenses within the housing, wherein each of the imaging lenses is configured to capture a portion of a document imaging area and wherein the imaging lenses are spaced relative to each other to capture the entire document imaging area;
a stationary two-dimensional array of color image sensors within the housing, the color image sensors defining an image plane and comprising light responsive pixels;
a stationary light source within the housing, wherein the light source is configured to illuminate i) a single portion of the document imaging area, ii) a plurality adjacent or non-adjacent portions of the document imaging area, and iv) all of the portions of the document imaging area; and
a stationary planar support coupled to the planar front section to secure and position a document for imaging;
wherein the portable desktop imaging processor is capable of capturing a full image or a partial image of the document via a mecahnically static optical and digital imaging process and is capable of being positioned on top of or below the document for the imaging process.

27. An image processing method comprising:
providing an image processing device;
receiving a signal indicative of a selection of one or more portions of a document to be imaged;
responsively causing the image processing device to illuminate, via a static light source, one or more portions of the document imaging area; and
responsively causing the image processing device to capture, via a plurality of static imaging lenses and static color imaging sensors, the selected one or more portions of the document.

28. The method of claim 10, further comprising:
displaying, via a video camera display, one or more portions of the document before the one or more portions are stored in an image memory.
